(19) United States
(12) Patent Application Publication
(10) Pub. No.: US 2026/0308038 A1
(43) Pub. Date: Oct. 8, 2026

(54) LASER THICKNESS CONTROL OF FUSION GLASS

(71) Applicant: CORNING INCORPORATED, CORNING, NY (US)

(72) Inventors: MICHAEL PETER GAJ, HUNTERSVILLE, NC (US); PHILIP ROBERT LEBLANC, CORNING, NY (US); WILLIAM ANTHONY WHEDON, CORNING, NY (US)

(21) Appl. No.: 19/491,451

(22) PCT Filed: May 16, 2024
(86) PCT No.: PCT/US2024/029603

§ 371 Date: Dec. 9, 2025

Related U.S. Application Data
(60) Provisional application No. 63/472,903, filed on Jun. 14, 2023.

(51) Int. Cl. C03B 17/06

(52) U.S. Cl. CPC C03B 17/067

(57) ABSTRACT

A system for forming a glass ribbon is provided comprising a glass forming body for formation of glass and a first laser module. The glass forming body is configured to enable molten glass to flow along a surface of the glass forming body to form a glass ribbon. The glass ribbon defines a first face with a width extending from a first edge to a second edge. The first laser module is configured to generate a first laser beam that is scanned at least partially along the width of the first face within a first scan angle range so as to apply heat to aid in thickness control of the glass ribbon. A first central facing direction of the first scan angle range for the first laser beam strikes the first face at a first central strike angle that is not normal to the first face.

### CROSS-REFERENCE TO RELATED APPLICATION

This application claims the benefit of priority under 35 U.S.C. § 119 of U.S. Provisional Application Ser. No. 63/472,903 filed on Jun. 14, 2023, the content of which is relied upon and incorporated herein by reference in its entirety.

### FIELD

Embodiments relate generally to systems and method for mounting one or more laser modules so that laser beams strike a molten glass surface at non-normal angles.

### BACKGROUND

Ribbon thickness control in glass formation is typically addressed by cooling the glass ribbon in a glass forming mechanism with air flow from a plurality of air flow tubes based on feedback from a thickness measurement gauge. However, these actuators have limitations due to their low spatial resolution and low speed of response. This puts a limit on the best sheet thickness performance that may be efficiently achieved. Moreover, the sheet thickness for glass products is often controlled manually. For manual control, line operators look at the sheet thickness and change the flow of air applied to the glass ribbon by manually changing the position of air flow valves one at a time to achieve the desired thickness profile. This process is tedious and often takes many minutes for a line operator to complete, as there may be around 200 or more air flow valves on each draw.

Improvements in the foregoing are desired.

### BRIEF SUMMARY

Precision thickness control systems have also been used to enable high-resolution thickness control across a face of molten glass during glass formation. The precision thickness control technology directs a laser beam towards molten glass. The laser beam is absorbed by the molten glass to raise the temperature of the molten glass, and this temperature increase causes a decrease in the viscosity of the molten glass material and creates a new surface tension equilibrium in the molten glass. The new surface tension equilibrium gets set in after the setting zone and results in a decrease in the thickness of the molten glass.

Access is often limited at locations where the implementation of precision thickness control systems is most effective (e.g., near the root level). Existing structures and cables introduce significant challenges to safely mount a precision thickness control system relative to glass manufacturing apparatus for high-resolution thickness control. Moreover, one precision thickness control system is typically unable to provide full coverage across a standard glass forming mechanism. Thus, multiple tools are likely needed to control the thickness across the full width of a molten glass ribbon using a standard tool mounted in a standard (normal to glass manufacturing apparatus) orientation.

Various embodiments discussed herein describe approaches to optimally integrate the precision thickness control platform into a glass manufacturing apparatus. This disclosure proposes strategies to position/stitch a thickness control platform module to optimize glass ribbon coverage and minimize capital investment required to obtain complete thickness control coverage across a face of the molten glass.

Various embodiments discussed herein contemplate approaches that position the laser modules so that laser beams generated therefrom are emitted in a non-normal orientation towards the face of the molten glass. In some embodiments, the laser beams are emitted at angles of up to around 50 degrees from a direction that is normal to the molten glass face so that the coverage of a single laser module is increased. Laser beams may also be scanned across a face of the molten glass across a scan angle range, with a central strike angle being defined in the center of this scan angle range. This central strike angle may be angularly offset from a direction that is normal to the face of the molten glass (e.g., providing “off-axis” scanning).

While positioning the laser modules in this manner may create issues with optical effects introduced by increased propagation distances and large incident angles, various embodiments discussed herein contemplate approaches for compensating for these optical effects. These features may enable embodiments discussed herein to effectively control the thickness of molten glass during glass formation to achieve high-resolution thickness control across the full width of a molten glass ribbon, and this may be accomplished while also reducing the total capital investment required, such as by using an overall lower number of laser modules. Additionally, where a lower number of laser modules are used, areas proximate to the molten glass may be made less congested (as space and access around the glass manufacturing apparatus is limited, such as due to safety standards, temperature values, and other control features).

Various embodiments discussed herein relate to methods to compensate for optical phenomenon and distortions caused by such off-axis laser beam scanning. These embodiments may use a static focus compensation and/or a dynamic focus compensation element in the precision thickness control system to compensate for beam divergence and maintain equal fluence across a scan field when a system numerical aperture value is greater than or equal to around 0.01. A precision thickness control system may include a spatial light modulator (SLM) or diffractive optical element (DOE) to compensate for cosine errors caused by a large strike angle on the glass. A precision thickness control system may also include an acoustic optic modulator or electro-optic modulator to rapidly adjust for Fresnel reflections and/or laser energy losses at scan speeds between about 1 kilohertz to about 1 megahertz. The scan speeds may be between about 1 kilohertz to about 10 kilohertz in some embodiments. Precision thickness control systems may use an acoustic optic modulator and/or an electro-optic modulator to rapidly modulate laser energy to minimize overshoot and/or undershoots caused by internal laser pulse-to-pulse variations between triggers.

Various embodiments discussed herein simplify precision thickness control module integration and reduce clutter around a glass manufacturing apparatus. For example, less usage of tools or other structures/mechanisms leads to a lower probability of creating a physical blockage of the laser beam path, which reduces and/or eliminates costly re-designs of key glass forming components. Furthermore, fewer tools or other structures/mechanisms may lead to a lower weight load on the glass manufacturing apparatus and a lower probability that a component in a glass forming mechanism may sag or be damaged. Less tools or other structures/mechanisms may also lead to less maintenance and less down time for production in the event a module needs to be serviced or replaced.

Glass formed using systems and methods described herein may be beneficial for use in glass hard disk drive substrate products, glass products in automobiles, and other glass products. Additionally, various embodiments discussed herein may minimize beam distortions during laser scanning, improve thickness control, and reduce processing variation across a glass ribbon. Additionally, various embodiments discussed herein may improve laser pulse-to-pulse stability and minimize variable pulse overshoot and/or undershoot during scanning, which may lead to greater process control and repeatability during operation. This may yield more quality glass with finer thickness control capabilities.

Various example embodiments utilize precision thickness control technology that adjusts heat from a laser system driven by a galvanometer-based steering mirror (e.g., a “galvo”) as opposed to adjusting cool air flow. Accordingly, the laser beam control systems may be used in combination with the precision thickness control laser actuator to reduce thickness variation in the sheet on the draw via closed loop feedback control. The inputs to the thickness uniformity control unit(s) include the thickness profile target (typically a flat thickness profile) and the current sheet thickness profile as measured by the thickness gauge. The output of the controller is a new laser power profile that may be sent to a laser and galvanometer control unit(s). Such a precision thickness control system offers the potential of high-resolution thickness control as a laser may be directed precisely across the glass ribbon and the energy may be precisely adjusted. Recent testing with precision thickness control systems has demonstrated that such systems may accomplish a full width half maximum resolution of less than 15 millimeters and a thickness control better than 1 micron.

In an example embodiment, a system for forming a glass ribbon is provided. The system comprises a glass forming body for formation of glass and a first laser module. The glass forming body is configured to enable molten glass to flow along a surface of the glass forming body to form a glass ribbon. The glass defines a first face with a width extending from a first edge to a second edge. The first laser module is configured to generate a first laser beam that is scanned at least partially along the width of the first face within a first scan angle range so as to apply heat to aid in thickness control of the glass ribbon. A first central facing direction of the first scan angle range for the first laser beam strikes the first face at a first central strike angle that is not normal to the first face.

In some embodiments, the first laser beam may be spread at least partially along the width of the glass ribbon between the first edge and the second edge. The first scan angle range may be equal to an angle range between a first scan angle and a second scan angle, with the first scan angle being a minimum angle at which a portion of the first laser beam strikes the first face and with the second scan angle being a maximum angle at which a portion of the first laser beam strikes the first face. Additionally, in some embodiments, the first scan angle range may be greater than about 40 degrees.

In some embodiments, the first central strike angle may be measured relative to a normal direction of the first face, and the first central strike angle is greater than zero degrees and less than about fifty degrees. In some embodiments, the first laser beam may cause an increase in a temperature at the glass ribbon at an impact area. The increase in the temperature may cause a decrease in a viscosity of the glass ribbon at the impact area, and the decrease in the viscosity of the glass ribbon may result in a decrease in the thickness of the glass ribbon at the impact area.

In some embodiments, the system may further comprise a second laser module, and the second laser module may be configured to generate a second laser beam that is scanned at least partially along the width of the first face within a second scan angle range so as to apply heat to aid in thickness control of the glass ribbon. The system may be configured such that a second central facing direction of the second scan angle range for the second laser beam strikes the first face at a second central strike angle. Additionally, in some embodiments, the first central strike angle and the second central strike angle may be the same. Furthermore, in some embodiments, the first central strike angle and the second central strike angle are different. In some embodiments, the second central strike angle may be equal to zero.

In some embodiments, the system may further comprise at least one optical element. The first laser module may be configured to emit the first laser beam towards the at least one optical element, and the at least one optical element may be configured to redirect the first laser beam towards the first face. Additionally, in some embodiments, the at least one optical element may comprise a reflector. Furthermore, the system may also comprise a regulating mechanism that is configured to adjust an orientation of the at least one optical element. Adjustment of the orientation of the at least one optical element may cause a change in a location where a laser beam contacts the first face of the glass ribbon.

In some embodiments, the system may also comprise a thickness sensor and a thickness control unit. The thickness sensor may be configured to determine a thickness of the glass ribbon at one or more locations. The thickness control unit may be configured to receive thickness data from the thickness sensor based on the thickness of the glass ribbon at the one or more locations. The thickness control unit may be configured to receive a target thickness profile, and the thickness control unit may be configured to generate a power profile based on at least the thickness data and the target thickness profile. The power profile may be configured to be used to control the operation of the first laser module. Additionally, in some embodiments, the glass ribbon responds to laser power according to a Gaussian response model, a double Gaussian response model, or a response model based on a raised cosine function or a Bessel function. Furthermore, in some embodiments, the target thickness profile may maintain a uniform thickness across the width of the glass ribbon. In some embodiments, the target thickness profile may maintain a variable thickness across the width of the glass ribbon.

In some embodiments, the system may further comprise at least one of an acoustic optic modulator or an electro optic modulator, and the acoustic optic modulator and the electro optic modulator may be configured to modulate a generated laser beam to form the first laser beam. Additionally, in some embodiments, the acoustic optic modulator and the electro optic modulator may be configured to cause the system to maintain a more uniform energy density at the first face relative to otherwise identical systems that do not include the acoustic optic modulator or the electro optic modulator. Furthermore, in some embodiments, the first central strike angle may be equal to about 30 degrees, the first laser beam may strike the first face with a minimum energy density and a maximum energy density, and the minimum energy density may be less than about 21 percent of the maximum energy density.

In some embodiments, the system may further comprise at least one of a spatial light modulator or a diffractive optical element, and the spatial light modulator or the diffractive optical element may be configured to compensate for cosine errors caused by large glass incident angles. In some embodiments, the glass forming body may comprise a root, and the first laser beam may strike the first face below the root of the glass forming body. In some embodiments, the glass forming body may comprise a root, and the first laser beam may strike the first face above the root of the glass forming body. In some embodiments, the first laser beam may comprise light having a wavelength between about 400 nanometers and about 11000 nanometers.

In another example embodiment, a method of manufacturing a system for providing laser thickness control is provided. The method comprises providing a glass forming body for the formation of glass, with glass forming body being configured to enable molten glass to flow along at least one surface of the glass forming body to form a glass ribbon. The glass ribbon defines a first face with a width extending from a first edge to a second edge. The method may also comprise providing a first laser module that is configured to generate a first laser beam that is scanned at least partially along the width of the first face within a scan angle range so as to apply heat to aid in thickness control of the glass ribbon that is formed into glass. The method may also comprise positioning the first laser module so that the first laser module directs the first laser beam towards the first face. The first face defines a normal direction that is normal to the first face, and the system is configured such that a central facing direction of the scan angle range for the first laser beam strikes the first face at a central strike angle that is not normal to the first face. In some embodiments, the method may also comprise providing a second laser module that is configured to generate a second laser beam that is scanned at least partially along the width of the first face within a second scan angle range so as to apply heat to aid in thickness control of the glass ribbon. The method may also comprise positioning the second laser module so that the second laser module directs the second laser beam towards the first face.

In another example embodiment, a laser system for forming a glass ribbon is provided. The laser system comprises a first laser module configured to generate a first laser beam that is scanned at least partially along a width of a first face of glass ribbon. The molten glass is configured to flow along a surface of a glass forming body to form a glass ribbon. The molten glass defines a first face with the width extending from a first edge to a second edge. The first laser beam is scanned within a first scan angle range along the width so as to apply heat to aid in thickness control of the glass ribbon. The first laser beam is aimed along the width such that a first central facing direction of the first scan angle range for the first laser beam strikes the first face at a first central strike angle that is not normal to the first face.

### BRIEF DESCRIPTION OF THE DRAWINGS

Reference will now be made to the accompanying drawings, which are not necessarily drawn to scale, and wherein:

FIG. 1 is a schematic view illustrating an example glass manufacturing apparatus, in accordance with some embodiments discussed herein;

FIG. 2A is a cross-sectional view illustrating an example glass manufacturing apparatus taken along lines A-A of FIG. 1, in accordance with some embodiments discussed herein;

FIG. 2B is an enlarged view of the area C within FIG. 2A, in accordance with some embodiments discussed herein;

FIG. 2C is a schematic view illustrating an example optical element being used to redirect a laser beam towards a face of molten glass, in accordance with some embodiments discussed herein;

FIGS. 3-8 are schematic views illustrating various example mounting approaches for laser modules, in accordance with some embodiments discussed herein;

FIG. 9 is a line graph illustrating coverage of a molten glass ribbon by a single module when different central strike angles are used, in accordance with some embodiments discussed herein;

FIG. 10 is a line graph illustrating the number of modules needed to obtain full coverage of a 3.5 meter molten glass ribbon when various central strike angles are used, in accordance with some embodiments discussed herein;

FIG. 11 is a line graph illustrating normalized beam energy delivered to molten glass at different scan angles when different central strike angles are used and where no focus compensation is used, in accordance with some embodiments discussed herein;

FIG. 12 is a line graph illustrating the normalized beam energy delivered to molten glass at different scan angles when different central strike angles are used and where focus compensation is used, in accordance with some embodiments discussed herein;

FIG. 13 is a block diagram illustrating an exemplary laser beam control system, in accordance with some embodiments discussed herein;

FIG. 14 is a line graph illustrating an example Gaussian response model for a thickness profile response, in accordance with some embodiments discussed herein;

FIG. 15 is a line graph illustrating an example double Gaussian response model for a thickness profile response, in accordance with some embodiments discussed herein;

FIG. 16 is a line graph illustrating example thickness error before and after optimization, in accordance with some embodiments discussed herein;

FIGS. 17A-17B are schematic views illustrating laser beams striking a molten glass face at different angles, in accordance with some embodiments discussed herein;

FIGS. 18A-18B are schematic views illustrating lengths that a laser beam travels at various angles before reaching molten glass material, in accordance with some embodiments discussed herein;

FIG. 19 is a line graph illustrating a length that a laser beam travels at various angles before reaching glass, in accordance with some embodiments discussed herein; and

FIG. 20 is a flow chart illustrating an example method for manufacturing a laser thickness control system, in accordance with some embodiments discussed herein.

### DETAILED DESCRIPTION

Example embodiments now will be described more fully hereinafter with reference to the accompanying drawings, in which some, but not all embodiments are shown. Any connections or attachments may be direct or indirect connections or attachments unless specifically noted otherwise. As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to include the specific value or endpoint referred to. If a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint, and independently of the other endpoint.

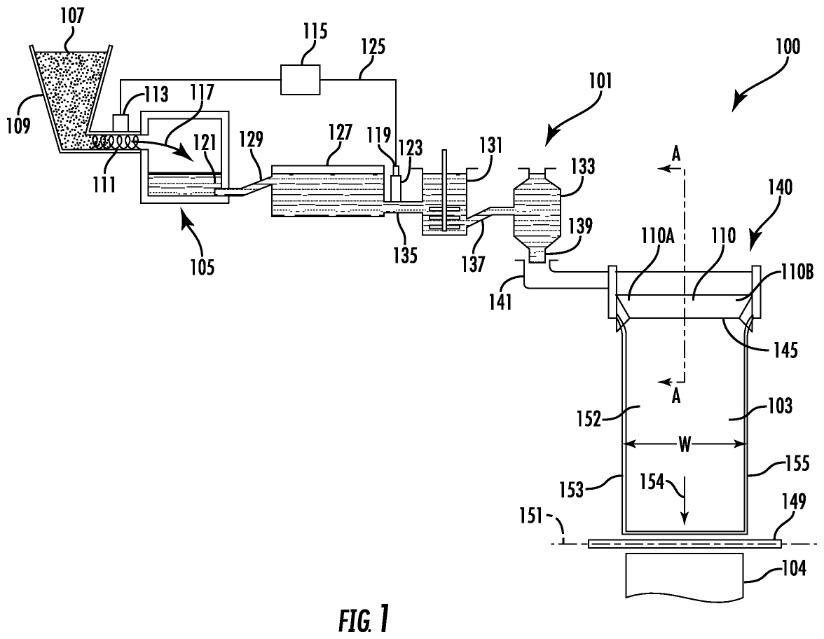

FIG. 1 is a schematic view illustrating an example glass manufacturing apparatus. As schematically illustrated in FIG. 1, in some embodiments, a glass manufacturing apparatus 100 may include a glass forming apparatus 101 including a glass forming body 140 designed to produce a glass ribbon 103 from a quantity of molten glass 121. In some embodiments, the glass ribbon 103 may include a central portion 152 disposed between opposite, relatively thick edge beads formed along a first outer edge 153 and a second outer edge 155 of the glass ribbon 103. Additionally, in some embodiments, a glass sheet 104 may be separated from the glass ribbon 103 along a separation path 151 by a glass separator 149 (e.g., scribe, score wheel, diamond tip, laser). In some embodiments, before or after separation of the glass sheet 104 from the glass ribbon 103, the relatively thick edge beads formed along the first outer edge 153 and the second outer edge 155 may be removed to provide the central portion 152 as a glass sheet 104 having a more uniform thickness.

In some embodiments, the glass manufacturing apparatus 100 may include a melting vessel 105 oriented to receive batch material 107 from a storage bin 109. The batch material 107 may be introduced by a batch delivery device 111 powered by a motor 113. In some embodiments, a controller 115 may optionally be operated to activate the motor 113 to introduce a desired amount of batch material 107 into the melting vessel 105, as indicated by arrow 117. The melting vessel 105 may heat the batch material 107 to provide molten glass 121. In some embodiments, a glass melt probe 119 may be employed to measure a level of molten glass 121 within a standpipe 123 and communicate the measured information to the controller 115 by way of a communication line 125.

Additionally, in some embodiments, the glass manufacturing apparatus 100 may include a first conditioning station including a fining vessel 127 located downstream from the melting vessel 105 and coupled to the melting vessel 105 by way of a first connecting conduit 129. In some embodiments, molten glass 121 may be gravity fed from the melting vessel 105 to the fining vessel 127 by way of the first connecting conduit 129. For example, in some embodiments, gravity may drive the molten glass 121 through an interior pathway of the first connecting conduit 129 from the melting vessel 105 to the fining vessel 127. Additionally, in some embodiments, bubbles may be removed from the molten glass 121 within the fining vessel 127 by various techniques.

In some embodiments, the glass manufacturing apparatus 100 may further include a second conditioning station including a mixing chamber 131 that may be located downstream from the fining vessel 127. The mixing chamber 131 may be employed to provide a homogenous composition of molten glass 121, thereby reducing or eliminating inhomogeneity that may otherwise exist within the molten glass 121 exiting the fining vessel 127. As shown, the fining vessel 127 may be coupled to the mixing chamber 131 by way of a second connecting conduit 135. In some embodiments, molten glass 121 may be gravity fed from the fining vessel 127 to the mixing chamber 131 by way of the second connecting conduit 135. For example, in some embodiments, gravity may drive the molten glass 121 through an interior pathway of the second connecting conduit 135 from the fining vessel 127 to the mixing chamber 131.

Additionally, in some embodiments, the glass manufacturing apparatus 100 may include a third conditioning station including a delivery vessel 133 that may be located downstream from the mixing chamber 131. In some embodiments, the delivery vessel 133 may condition the molten glass 121 to be fed into an inlet conduit 141. For example, the delivery vessel 133 may function as an accumulator and/or flow controller to adjust and provide a consistent flow of molten glass 121 to the inlet conduit 141. As shown, the mixing chamber 131 may be coupled to the delivery vessel 133 by way of a third connecting conduit 137. In some embodiments, molten glass 121 may be gravity fed from the mixing chamber 131 to the delivery vessel 133 by way of the third connecting conduit 137. For example, in some embodiments, gravity may drive the molten glass 121 through an interior pathway of the third connecting conduit 137 from the mixing chamber 131 to the delivery vessel 133. As further illustrated, in some embodiments, a delivery pipe 139 may be positioned to deliver molten glass 121 to the inlet conduit 141 of the glass forming body 140.

Various embodiments of forming vessels may be provided in accordance with features of the disclosure including a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the glass forming body 140 shown and disclosed below may be provided to fusion draw the molten glass 121 off a root 145 of a forming wedge 110 to produce the glass ribbon 103. For example, in some embodiments, the molten glass 121 may be delivered from the inlet conduit 141 to the glass forming body 140. The molten glass 121 may then be formed into the glass ribbon 103 based at least in part on the structure of the glass forming body 140. For example, as shown, the molten glass 121 may be drawn off the bottom edge (e.g., root 145) of the glass forming body 140 along a draw path extending in a draw direction 154 of the glass manufacturing apparatus 100. In some embodiments, edge directors may direct the molten glass 121 off the glass forming body 140 and define, at least in part, a width “W” of the glass ribbon 103. In some embodiments, the width “W” of the glass ribbon 103 may extend between the first outer edge 153 of the glass ribbon 103 and the second outer edge 155 of the glass ribbon 103.

In some embodiments, the width “W” of the glass ribbon 103 may be about 20 millimeters or more, about 50 millimeters or more, about 100 millimeters or more, about 500 millimeters or more, about 1,000 millimeters or more, about 2,000 millimeters or more, about 3,000 millimeters or more, about 4000 millimeters or more, although other widths may be provided in further embodiments. In some embodiments, the width “W” of the glass ribbon 103 may be in a range from about 20 millimeters to about 4,000 millimeters, from about 50 millimeters to about 4,000 millimeters, from about 100 millimeters to about 4,000 millimeters, from about 500 millimeters to about 4,000 millimeters, from about 1,000 millimeters to about 4,000 millimeters, from about 2,000 millimeters to about 4,000 millimeters, from about 3,000 millimeters to about 4,000 millimeters, from about 20 millimeters to about 3,000 millimeters, from about 50 millimeters to about 3,000 millimeters, from about 100 millimeters to about 3,000 millimeters, from about 500 millimeters to about 3,000 millimeters, from about 1,000 millimeters to about 3,000 millimeters, from about 2,000 millimeters to about 3,000 millimeters, from about 2,000 millimeters to about 2,500 millimeters, and all ranges and subranges therebetween.

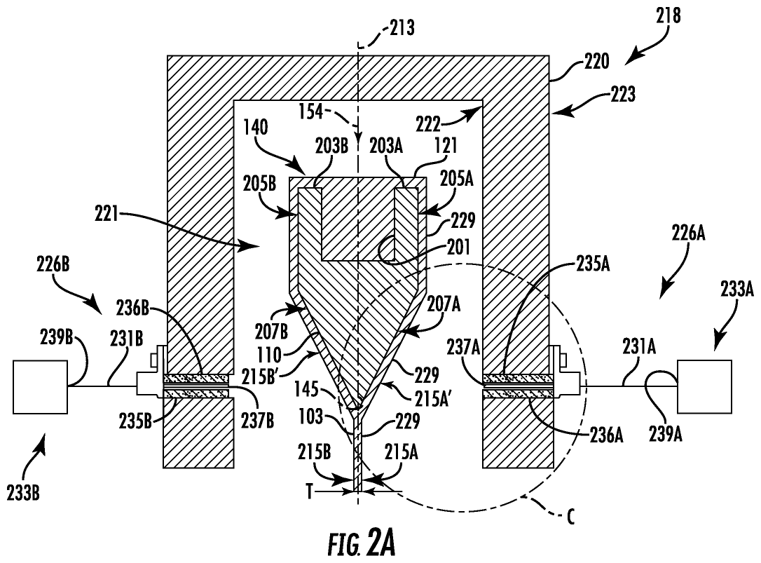

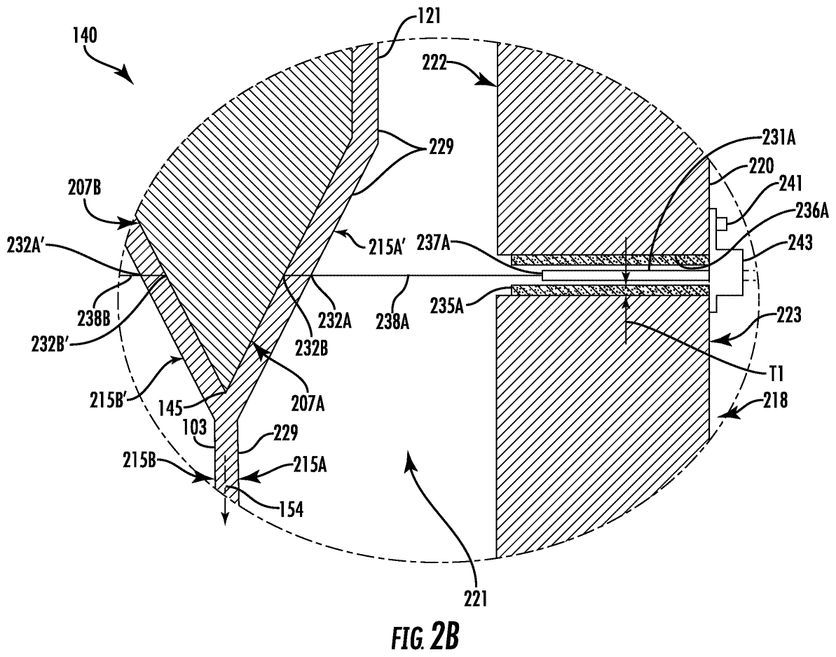

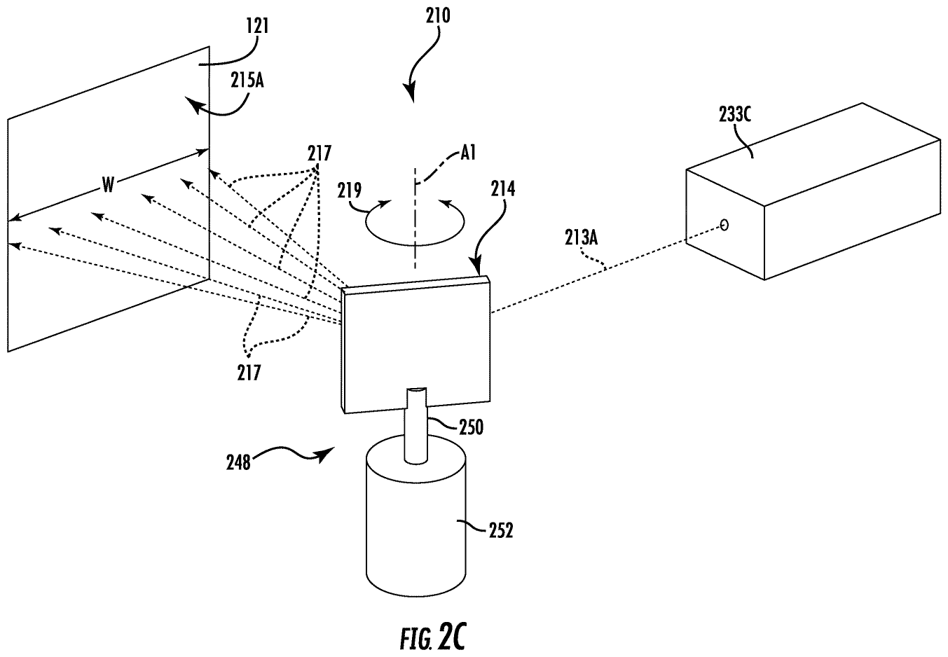

FIG. 2A is a cross-sectional view illustrating an example glass manufacturing apparatus taken along lines A-A of FIG. 1. In some embodiments, the glass forming body 140 may include a trough 201 oriented to receive the molten glass 121 from the inlet conduit 141. The glass forming body 140 may further include the forming wedge 110 including a pair of downwardly inclined converging surface portions 207A, 207B extending between opposed ends 110A, 110B (see FIG. 1) of the forming wedge 110. The pair of downwardly inclined converging surface portions 207A, 207B of the forming wedge 110 may converge along the draw direction 154 to intersect along a bottom edge of the forming wedge 110 to define the root 145 of the glass forming body 140. A draw plane 213 of the glass manufacturing apparatus 100 may extend through the root 145 along the draw direction 154. In some embodiments, the glass ribbon 103 may be drawn in the draw direction 154 along the draw plane 213. As shown, the draw plane 213 may bisect the forming wedge 110 through the root 145 although, in some embodiments, the draw plane 213 may extend at other orientations relative to the root 145.

Throughout the disclosure, the molten glass travel path 229 is defined as the path that the molten glass 121 follows from when it enters the glass forming body 140 until it has cooled to its strain point (i.e., the temperature at which the viscosity of the molten glass 121 comprising the glass ribbon 103 exceeds 10^{14.5} Poise). The molten glass 121 may cool to its strain point as a glass ribbon 103 before it reaches the separation path 151 (see FIG. 1), although the molten glass 121 may cool to its strain point after it crosses the separation path 151 as a glass sheet 104 in further embodiments. For instance, as shown in FIGS. 2A-2B, the molten glass travel path 229 may be defined as the path the molten glass 121 travels as it flows over the inclined converging surface portions 207A, 207B and/or the path that the glass ribbon 103 travels after it is drawn off the root 145 of the forming wedge 110.

Additionally, in some embodiments, the molten glass 121 flows into the trough 201 of the glass forming body 140 and then overflows from the trough 201 by simultaneously flowing over corresponding weirs 203A, 203B and downward over the outer surfaces 205A, 205B of the corresponding weirs 203A, 203B. Respective streams of molten glass 121 flow along corresponding downwardly inclined converging surface portions 207A, 207B of the forming wedge 110 to be drawn off the root 145 of the glass forming body 140, where the flows converge and fuse into the glass ribbon 103. The glass ribbon 103 may then be drawn off the root 145 in the draw plane 213 along the draw direction 154. In some embodiments, the glass separator 149 (see FIG. 1) may then separate the glass sheet 104 (see FIG. 1) from the glass ribbon 103 along the separation path 151. As illustrated, in some embodiments, the separation path 151 may extend along the width W of the glass ribbon 103 between the first outer edge 153 and the second outer edge 155. Additionally, in some embodiments, the separation path 151 may extend perpendicular to the draw direction 154 of the glass ribbon 103. Moreover, in some embodiments, the draw direction 154 may define a direction along which the glass ribbon 103 may be fusion drawn from the glass forming body 140. In some embodiments, the glass ribbon 103 may travel at a speed as it traverses along draw direction 154 of about 1 millimeter per second or more, about 10 millimeters per second or more, about 50 millimeters per second or more, about 100 millimeters per second or more, or about 500 millimeters per second or more, for example, in a range from about 1 millimeter per second to about 500 millimeters per second, from about 10 millimeters per second to about 500 millimeters per second, from about 50 millimeters per second to about 500 millimeters per second, from about 100 millimeters per second to about 500 millimeters per second, and all ranges and subranges therebetween.

As shown in FIG. 2A, in some embodiments, the glass ribbon 103 is drawn from the root 145 with a face 215A of the glass ribbon 103 and a face 215B of the glass ribbon 103 facing opposite directions and defining an average thickness T of the glass ribbon 103. In some embodiments, the average thickness T of the central portion 152 (see FIG. 1) of the glass ribbon 103 may be about 5 millimeters or less, about 4 millimeters or less, about 3 millimeters or less, about 2 millimeters or less, about 1 millimeter or less, about 500 micrometers, about 300 micrometers or less, about 200 micrometers or less, about 100 micrometers or less, although other thicknesses may be provided in further embodiments. For example, in some embodiments, the average thickness T of the glass ribbon 103 may be in a range from about 50 micrometers to about 750 micrometers, from about 100 micrometers to about 700 micrometers, from about 200 micrometers to about 600 micrometers, from about 300 micrometers to about 500 micrometers, from about 50 micrometers to about 500 micrometers, from about 50 micrometers to about 700 micrometers, from about 50 micrometers to about 600 micrometers, from about 50 micrometers to about 500 micrometers, from about 50 micrometers to about 400 micrometers, from about 50 micrometers to about 300 micrometers, from about 50 micrometers to about 200 micrometers, or from about 50 micrometers to about 100 micrometers, including all ranges and subranges of thicknesses therebetween. In addition, the glass ribbon 103 may include a variety of compositions including, but not limited to, soda-lime glass, aluminosilicate glass, borosilicate glass, aluminoborosilicate glass, alkali-containing glass, or alkali-free glass, any of which may be free of lithia or not.

In some embodiments, as shown in FIGS. 2A-2B, the glass manufacturing apparatus 100 may comprise a housing 218 with a housing wall 220 defined between an inner surface 222 and an outer surface 223 of the housing wall 220. In some embodiments, an interior 221 of the housing 218 may be at least partially defined by the inner surface 222 of the housing wall 220. In some embodiments, the housing wall 220 at least partially surrounds the glass forming body 140 so that the glass forming body 140 and a portion of the glass ribbon 103 are positioned within the interior 221 of the housing 218. As shown, a bulk material of the housing 218, located between the inner surface 222 and the outer surface 223, comprises a first material, which may be a ceramic or other material with a low thermal conductivity. Without wishing to be bound by theory, materials comprising lower thermal conductivities tend to comprise better insulating properties than materials with higher thermal conductivities. In some embodiments, the first material comprises a thermal conductivity of about 150 W m⁻¹ K⁻¹ or less, 50 W m⁻¹ K⁻¹ or less, of about 30 W m⁻¹ K⁻¹ or less, in a range from about 0.01 W m⁻¹ K⁻¹ to about 150 W m⁻¹ K⁻¹, in a range from about 0.01 W m⁻¹ K⁻¹ to about 50 W m⁻¹ K⁻¹, or in a range from about 0.25 W m⁻¹ K⁻¹ to about 30 W m⁻¹ K⁻¹, although other thermal conductivities may be permissible in other embodiments.

Also, the material of the housing 218 maintains its mechanical properties and dimensional stability at an operating temperature of the interior 221 of the housing 218 when there is molten glass 121 in the glass forming body 140. In some embodiments, the operating temperature may be about 500 degrees Celsius or more, about 800 degrees Celsius or more, about 1000 degrees Celsius or more, about 1200 degrees Celsius or more, about 1500 degrees Celsius or more, about 1700 degrees Celsius or less, or about 1600 degrees Celsius or less. In some embodiments, the operating temperature may be in a range from about 500 degrees Celsius to about 1700 degrees Celsius, from about 800 degrees Celsius to about 1700 degrees Celsius, from about 1000 degrees Celsius to about 1700 degrees Celsius, from about 1200 degrees Celsius to about 1700 degrees Celsius, from about 500 degrees Celsius to about 1600 degrees Celsius, from about 800 degrees Celsius to about 1600 degrees Celsius, from about 1000 degrees Celsius to about 1600 degrees Celsius, or from about 1200 degrees Celsius to about 1600 degrees Celsius. In some embodiments, the material of the housing 218 comprises a melting temperature above 1600 degrees Celsius. If the material of the housing 218 comprises an amorphous material, the operating temperature may be below the glass transition temperature of that material. In some embodiments, the first material comprises boron nitride (BN), silicon carbide (SiC), zirconium dioxide (ZrO₂), a SiAlON (i.e., a combination of alumina and silicon nitride and may have a chemical formula such as Si₁₂₋ₘ₋ₙAlₘ₊ₙOₙN₁₆₋ₙ, Si₆₋ₙAlₙOₙN₈₋ₙ, or Si₂₋ₙAlₙO¹⁺ⁿN₂₋ₙ, where m, n, and the resulting subscripts are all non-negative integers), aluminum nitride (AlN), graphite, alumina (Al₂O₃), silicon nitride (Si₃N₄), fused quartz, mullite (i.e., a mineral comprising a combination of aluminum oxide and silicon dioxide), or a combination of two or more of the aforementioned materials.

The glass manufacturing apparatus 100 may comprise one or more heating apparatuses. For example, as illustrated in FIG. 2A, the glass manufacturing apparatus 100 comprises a first heating apparatus 226A and a second heating apparatus 226B with the draw plane 213 positioned between the first heating apparatus 226A and the second heating apparatus 226B. Although two heating apparatuses 226A, 226B are shown, a single heating apparatus or more than two heating apparatus may be provided in other embodiments. FIG. 2B is an enlarged view taken at view C of FIG. 2A. FIG. 2B illustrates features of the first heating apparatus 226A, which will be described more fully with the understanding that such description may also apply to one or more other heating apparatus such as the second heating apparatus 226B.

In some embodiments, as shown in FIGS. 2A-2B, passages 236A, 236B extend through the housing 218 from the outer surfaces. For example, a first passage 236A extends through the housing 218 from the outer surface 223 of the housing wall 220 to the inner surface 222 of the housing wall 220. In some embodiments, as shown in FIGS. 2A-2B, a first tube 235A comprising a second material may be positioned within the first passage 236A and a second tube 235B comprising a second material may be positioned within the second passage 236B. However, the passages 236A, 236B may be provided without any tubes 235A, 235B and/or comprise a second material in other embodiments.

In some embodiments, the tubes 235A, 235B comprise the second material that may be the same as the first material of the housing wall 220. In some embodiments, the second material may comprise a thermal conductivity that is about the same or greater than a thermal conductivity of the first material. In further embodiments, the second material may still comprise a melting temperature of about 1600 degrees Celsius or more. For example, the first material may comprise a thermal conductivity less than about 25 W m⁻¹ K⁻¹ (e.g., fused quartz, fused silica, zirconium dioxide, mullite, a SiAlON, graphite) and the second material may comprise a thermal conductivity of about 30 W m⁻¹ K⁻¹ or more (e.g., silicon nitride, boron nitride, alumina, silicon carbide, aluminum nitride). In some embodiments, the second material may serve to homogenize temperatures within the passages 236A, 236B relative to a passage without the second material (e.g., without tubes 235A, 235B).

Each of the passages 236A, 236B may comprise a cross-section with a cross-sectional passage area. In some embodiments the cross-sectional passage area may be about 2,000 millimeters squared to about 12,000 millimeters squared, about 4,000 millimeters squared to about 10,000 millimeters squared, or about 6,000 millimeters squared to about 8,000 millimeters squared. In some embodiments, the cross-sectional passage area may be minimized to reduce the amount of heat transferred through each of the passages 236A, 236B while still accommodating an optical fiber 231A, 231B that may extend into each of the passages 236A, 236B, a tube 235A, 235B if present, and laser beams 238A, 238B. However, while optical fibers 231A, 231B are included in the embodiment illustrated in FIGS. 2A and 2B, systems may be provided without any optical fibers 231A, 231B in other embodiments. Where no optical fibers are included, laser beams may be emitted from the laser modules 233A, 233B so that the laser beams are directed towards molten glass.

As shown in FIG. 2A, the first heating apparatus 226A may also comprise a first laser module 233A, and the second heating apparatus 226B may also comprise a second laser module 233B. Laser modules 233A, 233B may comprise a gas laser, an excimer laser, a dye laser, or a solid-state laser. Example embodiments of gas lasers include helium, neon, argon, krypton, xenon, helium-neon (HeNe), xenon-neon (XeNe), carbon dioxide (CO2), coper (Cu) vapor, gold (Au) vapor, cadmium (Cd) vapor, ammonia, hydrogen fluoride (HF), and deuterium fluoride (DF). Example embodiments of excimer lasers include chlorine, fluorine, iodine, or dinitrogen oxide (N₂O) in an inert environment comprising argon (Ar), krypton (Kr), xenon (Xe), or a combination thereof. Example embodiments of dye lasers include those using organic dyes such as rhodamine, fluorescein, coumarin, stilbene, umbelliferone, tetracene, or malachite green dissolved in a liquid solvent. Example embodiments of solid-state lasers include crystal lasers, fiber lasers, and laser diodes. Crystal-based lasers comprise a host crystal doped with a lanthanide or a transition metal. Example embodiments of host crystals include yttrium aluminum garnet (YAG), yttrium lithium fluoride (YLF), yttrium othoaluminate (YAL), yttrium scandium gallium garnet (YSSG), lithium aluminum hexafluoride (LiSAF), lithium calcium aluminum hexafluoride (LiCAF), zinc selenium (ZnSe), ruby, forsterite, and sapphire. Example embodiments of dopants include neodymium (Nd), titanium (Ti), chromium (Cr), iron (Fe), erbium (Er), holmium (Ho), thulium (Tm), ytterbium (Yb), dysprosium (Dy), cerium (Ce), gadolinium (Gd), samarium (Sm), and terbium (Tb). Example embodiments of solid crystals include ruby, alexandrite, chromium fluoride, forsterite, lithium fluoride (LiF), sodium chloride (NaCl), potassium chloride (KCl), and rubidium chloride (RbCl). Laser diodes may comprise heterojunction or PIN diodes with three or more materials for the respective p-type, intrinsic, and n-type semiconductor layers. Example embodiments of laser diodes include AlGaInP, AlGaAs, InGaN, InGaAs, InGaAsP, InGaAsN, InGaAsNSb, GaInP, GaAlAs, GaInAsSb, and lead (Pb) salts. Some laser diodes may represent exemplary embodiments because of their size, tunable output power, and ability to operate at room temperature, which may range from about 20 degrees Celsius to about 25 degrees Celsius. As described below, fiber lasers comprise an optical fiber that further comprises a cladding with any of the materials listed above for crystal lasers or laser diodes.

The laser modules 233A, 233B are configured to emit laser beams 238A, 238B (see FIG. 2B) that each comprise a wavelength. The laser modules 233A, 233B may be operated such that the wavelengths of the laser beams 238A, 238B are reduced by half (frequency doubled), reduced by two-thirds (frequency tripled), reduced by three-fourths (frequency quadrupled), or otherwise modified relative to a natural wavelength of laser beams 238A, 238B produced by the laser modules 233A, 233B. In some embodiments, the wavelength of the laser beams 238A, 238B may be between about 400 nanometers and about 11000 nanometers. In some embodiments, the wavelength of the laser beams 238A, 238B may be about 760 nanometers or more, about 900 nanometers or more, about 980 nanometers or more, about 5,000 nanometers or less, about 4,000 nanometers or less, about 3,000 nanometers, or less, about 1,700 nanometers or less, about 1,660 nanometers or less, about 1,570 nanometers or less, about 1,330 nanometers or less, or about 1,100 nanometers or less. In some embodiments, the wavelength of the laser beams 238A, 238B may be in a range from about 760 nanometers to about 5,000 nanometers, from about 760 nanometers to about 4,000 nanometers, from about 760 nanometers to about 3,000 nanometers, from about 760 nanometers to about 1,700 nanometers, from about 760 nanometers to about 1,660 nanometers, from about 760 nanometers to about 1,570 nanometers, from about 760 nanometers to about 1,330 nanometers, from about 760 nanometers to about 1,100 nanometers, from about 900 nanometers to about 5,000 nanometers, from about 900 nanometers to about 4,000 nanometers, from about 900 nanometers to about 3,000 nanometers, from about 900 nanometers to about 1,700 nanometers, from about 900 nanometers to about 1,660 nanometers, from about 900 nanometers to about 1,570 nanometers, from about 900 nanometers to about 1,330 nanometers, from about 900 nanometers to about 1,100 nanometers, from about 980 nanometers to about 5,000 nanometers, from about 980 nanometers to about 4,000 nanometers, from about 980 nanometers to about 3,000 nanometers, from about 980 nanometers to about 1,700 nanometers, from about 980 nanometers to about 1,660 nanometers, from about 980 nanometers to about 1,570 nanometers, from about 980 nanometers to about 1,330 nanometers, or from about 980 nanometers to about 1,100 nanometers. Exemplary embodiments of a laser diode capable of producing laser beams 238A, 238B with a wavelength within the aforementioned ranges include an AlGaAs, an InGaAsP, an InGaAsN laser diode. Exemplary embodiments of laser modules 233A, 233B (other than a diode laser) capable of producing laser beams 238A, 238B with a wavelength within the aforementioned ranges include a He—Ne gas laser, an Ar gas laser, an iodine excimer laser, a Nd doped YAG solid-state laser, a Nd doped YLF solid-state laser, a Nd doped YAP solid-state laser, a Ti doped sapphire solid-state laser, a Cr doped LiSAF solid-state laser, a chromium fluoride solid-state laser, a forsterite solid-state laser, a LiF solid-state laser, and a NaCl solid-state laser. Exemplary embodiments of laser modules 233A, 233B that may produce laser beams 238A, 238B with a wavelength within the aforementioned ranges when frequency-doubled include a XeNe gas laser, a HF gas laser, a Ho doped YAG solid-state laser, an Er doped YAG solid-state laser, a Tm doped YAG solid-state laser, a KCl solid-state laser, a RbCl solid-state laser, and an AlGaIn laser diode. In some embodiments, the laser modules 233A, 233B may comprise a carbon dioxide (CO₂) laser, and the laser modules 233A, 233B may operating between wavelengths of about 8,000 nanometers and about 12,000 nanometers, between about 8,500 nanometers and about 11,500 nanometers, and between about 9,000 nanometers and about 11,000 nanometers. In some embodiments, the laser modules 233A, 233B may comprise a carbon monoxide (CO) laser, and the laser modules 233A, 233B may operate between wavelengths of about 2,500 nanometers and about 7,500 nanometers, between about 4,000 nanometers and about 6,000 nanometers, or at a wavelength of about 5,000 nanometers. Exemplary embodiments of laser modules 233A, 233B that may produce laser beams 238A, 238B with a wavelength within the aforementioned ranges when frequency-tripled include a HeNe gas laser, a DF gas laser, and a Pb salt laser diode.

The laser beams 238A, 238B may be configured to contact a face of the molten glass 121. For example, in FIG. 2B, the laser beam 238A is configured to contact the face 215A′ of the molten glass 121, and the laser beam 238B is configured to contact the face 215B′ of the molten glass 121. The faces 215A′, 215B′ are each above the root 145. However, in other embodiments, the laser beam 238A may contact the face 215A of the molten glass 121 and the laser beam 238B may contact the face 215B of the molten glass 121, with the faces 215A, 215B being below the root 145 of the glass forming body 140.

As shown in FIG. 2B, the heating apparatuses 226A, 226B may also optionally comprise optical fibers 231A, 231B. However, in some embodiments, these optical fibers 231A, 231B are not included. The optical fiber 231A, 231B may each comprise a first end 239A, 239B (see FIG. 2A) and second ends 237A, 237B (see FIG. 2A) opposite the first ends 239A, 239B. Throughout the disclosure, the length of an optical fiber is defined as the distance between a first point at the first ends of the optical fiber and a second point at the second ends of the optical fiber when the optical fiber is straightened so that it is aligned with an elongated axis and the first point and the second point are as far apart as possible. In some embodiments, the length of the optical fibers 231A, 231B may be about 100 millimeters or more, about 1 meter or more, about 2 meters or more, about 5 meters or more, about 2,000 meters or less, about 50 meters or less, about 30 meters or less, about 20 meters or less, or about 10 meters or less. In some embodiments, the length of the optical fibers 231A, 231B may be in a range from about 100 millimeters to about 2,000 meters, from about 100 millimeters to about 50 meters, from about 100 millimeters to about 30 meters, from about 100 millimeters to about 20 meters, from about 100 millimeters to about 10 meters, from about 1 meter to about 2,000 meters, from about 1 meters to about 50 meters, from about 1 meter to about 30 meters, from about 1 meter to about 20 meters, from about 1 meter to about 10 meters, from about 2 meters to about 30 meters, from about 2 meters to about 20 meters, from about 2 meters to about 10 meters, or from about 5 meters to about 10 meters.

The optical fibers 231A, 231B may comprise a core comprising an optical material. Throughout the disclosure, a width of the core of an optical fiber is defined as a distance between a first point at a second end of the optical fiber and a second point at the second end of the optical fiber, where the first point and the second point comprise the same material as the center of the second end of the fiber and the first point and the second point are as far apart as possible. For example, the width of the core of an optical fiber may be equal to the diameter when the core of the second end of the optical fiber is circular. When the core of the second end of the optical fiber is elliptical, the width is equal to twice the semi-major axis. In some embodiments, the width of the core of the optical fibers 231A, 231B may be about 1 micrometer or more, about 5 micrometers or more, about 9 micrometers or more, about 50 micrometers or more, about 62.5 micrometers or more, about 550 micrometers or less, about 490 micrometers or less, about 400 micrometers or less, about 360 micrometers or less, about 255 micrometers or less, or about 145 micrometers or less. In some embodiments, the width of the core of the optical fibers 231A, 231B may be in a range from about 1 micrometer to about 550 micrometers, from about 1 micrometer to about 490 micrometers, from about 1 micrometer to about 400 micrometers, from about 1 micrometer to about 360 micrometers, from about 1 micrometer to about 255 micrometers, from about 1 micrometer to about 145 micrometers, from about 5 micrometers to about 550 micrometers, from about 5 micrometers to about 490 micrometers, from about 5 micrometers to about 255 micrometers, from about 9 micrometers to about 550 micrometers, from about 9 micrometers to about 490 micrometers, from about 9 micrometers to about 400 micrometers, from about 9 micrometers to about 360 micrometers, from about 9 micrometers to about 250 micrometers, from about 9 micrometers to about 144 micrometers, from about 50 micrometers to about 550 micrometers, from about 50 micrometers to about 490 micrometers, from about 50 micrometers to about 400 micrometers, from about 50 micrometers to about 144 micrometers, from about 62.5 micrometers to about 550 micrometers, from about 62.5 micrometers to about 550 micrometers, from about 62.5 micrometers to about 490 micrometers, from about 62.5 micrometers to about 400 micrometers, from about 62.5 micrometers to about 360 micrometers, from about 62.5 micrometers to about 255 micrometers, from about 62.5 micrometers to about 150 micrometers.

In some embodiments, the optical material in the core of the optical fibers 231A, 231B comprise sapphire, fused silica, quartz, or a combination thereof. In further embodiments, the optical material may be doped with an optical amplifier such as erbium (Er), ytterbium (Yb), neodymium (Nd), or germanium dioxide (GeO2). In some embodiments, the optical fibers 231A, 231B may comprise a cladding surrounding the core. In further embodiments, the cladding may comprise a lower refractive index than a refractive index of the core. In even further embodiments, the cladding may comprise fused silica, quartz, sapphire, or gas, for example air, nitrogen, or argon. In other even further embodiments, the cladding may comprise any of the materials listed above for laser diodes or crystal lasers. Doping, cladding, or a combination of the two may be desirable to modify the amplitude of laser beams 238A, 238B being transmitted by the optical fibers 231A, 231B (e.g., the optical fiber may be a fiber laser). In some embodiments, the core of the optical fibers 231A, 231B may comprise a circular cross-section. An optical fiber with a core comprising a circular cross-section may provide the laser beams 238A, 238B exiting the second ends 237A, 237B of the optical fibers 231A, 231B with a smooth (e.g., homogenous and symmetric) intensity profile. In some embodiments, the first ends 239A, 239B of the optical fibers 231A, 231B may comprise a circular cross-section, and the second ends 237A, 237B of the optical fibers 231A, 231B may comprise a circular cross-section. Providing the optical fibers 231A, 231B with a circular cross-section may, in some embodiments, be used with passages 236A, 236B and/or tubes 235A, 235B with a circular cross-section.

Looking now at FIG. 2B, the tubes 235A, 235B may comprise a thickness T1 measured between an outer dimension of the tubes 235A, 235B and an inner dimension of the tubes 235A, 235B. In some embodiments, the thickness T1 of the tubes 235A, 235B that may be about 100 nanometers or more, about 1 micrometers or more, about 10 micrometers or more, about 50 micrometers or more, about 2,000 micrometers or less, about 990 micrometers or less, about 490 micrometers or less, about 400 micrometers or less, about 300 micrometers or less, about 200 micrometers or less, or about 100 micrometers or less. In some embodiments, the thickness T1 of the tubes 235A, 235B may be in a range from about 100 nanometers to about 2,000 micrometers, from about 1 micrometers to about 2,000 micrometers, from about 10 micrometers to about 2,000 micrometers, from about 50 micrometers to about 2,000 micrometers, from about 100 nanometers to about 990 micrometers, from about 1 micrometers to about 990 micrometers, from about 10 micrometers to about 990 micrometers, from about 50 micrometers to about 990 micrometers, from about 100 nanometers to about 490 micrometers, from about 1 micrometers to about 490 micrometers, from about 10 micrometers to about 490 micrometers, from about 50 micrometers to about 490 micrometers, from about 100 nanometers to about 400 micrometers, from about 1 micrometers to about 400 micrometers, from about 10 micrometers to about 400 micrometers, from about 50 micrometers to about 400 micrometers, from about 100 nanometers to about 300 micrometers, from about 1 micrometers to about 300 micrometers, from about 10 micrometers to about 300 micrometers, from about 50 micrometers to about 300 micrometers, from about 100 nanometers to about 200 micrometers, from about 1 micrometers to about 200 micrometers, from about 10 micrometers to about 200 micrometers, from about 50 micrometers to about 200 micrometers, from about 100 nanometers to about 100 micrometers, from about 1 micrometers to about 100 micrometers, from about 10 micrometers to about 100 micrometers, or from about 50 micrometers to about 100 micrometers.

In some embodiments, as shown in FIGS. 2A-2B, the optical fibers 231A, 231B may extend into passages 236A, 236B in the housing 218. In further embodiments, the optical fibers 231A, 231B may extend fully through the housing 218 in a passage 236A, 236B. In even further embodiments, the optical fibers 231A, 231B may extend fully through the tubes 235A, 235B in passages 236A, 236B. In other further embodiments, as shown in FIGS. 2A-2B, the optical fibers 231A, 231B may partially extend through the tubes 235A, 235B in passages 236A, 236B. In other embodiments, although not shown, the optical fibers 231A, 231B may partially extend through the tubes 235A, 235B in a portion of the tubes 235A, 235B outside of passages 236A, 236B. In still other embodiments, although not shown, the optical fibers 231A, 231B may not extend into passages 236A, 236B in the housing 218 at all with the laser beams 238A, 238B being transmitted through each of the passages 236A, 236B in the housing 218.

In some embodiments, as illustrated in FIG. 2B, the tubes 235A, 235B may be held in place by a faceplate. For example, the faceplate 243 may hold the tube 235A in place. Additionally or alternatively, the faceplate 243 may act to cap the passage 236A, 236B to minimize heat loss through the passage 236A, 236B. The faceplate 243 may be connected to the outer surface 223 of the housing 218 by a fastener 241 or other attachment device. In some embodiments, the fastener 241 may comprise a rivet, a nail, a screw, a bolt, a snap, a clasp, a buckle, a hook-and-loop fastener, a latch, a cable tie, a strap, a pin, or a peg. Additionally, faceplates such as faceplate 243 may act to minimize thermal loss from any space between an interior surface of the tubes 235A, 235B and the surface of the passages 236A, 236B in the housing 218.

The optical fibers 231A, 231B may be positioned so that the second ends 237A, 237B of the optical fibers 231A, 231B face the molten glass travel path 229. In some embodiments, as shown in FIGS. 2A-2B, the optical fibers 231A, 231B partially extend through the passages 236A, 236B. In some embodiments, although not shown, the optical fibers 231A, 231B face the passages 236A, 236B but do not extend into the passages 236A, 236B. In some embodiments, although not shown, optical fibers 231A, 231B may fully extend through the passages 236A, 236B and protrude beyond the inner surface 222 of the housing 218 into the interior 221. In some embodiments, an optical element may be placed between the second ends 237A, 237B of the optical fibers 231A, 231B and the molten glass travel path 229. In some embodiments, a distance between the second ends 237A, 237B of the optical fibers 231A, 231B and the optical element may be fixed by attaching the optical element to a transparent material (e.g., a material suitable to be used as the core of the optical fibers 231A, 231B) and the second ends 237A, 237B of the optical fibers 231A, 231B, where a refractive index of the transparent material is about the same or less than a refractive index of the core of the optical fibers 231A, 231B. In other embodiments, a distance between the second ends 237A, 237B of the optical fibers 231A, 231B and the optical element may be variable. For example, the optical element may be attached to an end of the passages 236A, 236B closest to the interior 221 of the housing 218 while the optical fibers 231A, 231B may be moved independently in the passages 236A, 236B. An exemplary optical element may be a collimating lens, which acts to control the divergence of laser beams 238A, 238B exiting the second ends 237A, 237B of the optical fibers 231A, 231B. In some embodiments, the collimating lens may be spherical, elliptical, or cylindrical. In some embodiments, there may be more than one lens as part of the optical element.

A power density and/or size of the laser beams 238A, 238B impinging on a portion of the molten glass 121 on the molten glass travel path 229 may be achieved in a wide range of ways such as one or more of: adjusting a position of the second ends 237A, 237B of the optical fibers 231A, 231B, the type of optical element, or a position of the optical element. Throughout the disclosure, a width of laser beams 238A, 238B impinging on a portion of molten glass 121 is defined as the distance in a direction across a molten glass travel path 229 between a first point on the molten glass 121 impinged by the laser beams 238A, 238B and a second point on the molten glass 121 impinged by the laser beams 238A, 238B with an intensity that may be about 13.5% (i.e., 1/e²) of a maximum intensity of the laser beams 238A, 238B at a location on the molten glass 121, where the first point and the second point are as far apart as possible in the direction across the molten glass travel path 229. While beam profiles for laser beams 238A, 238B may be Gaussian beam profiles, non-Gaussian beam profiles (e.g., top-hat shaped beams) are suitable as well as non-round beams (e.g., elliptical shaped beams). In some embodiments, the maximum width of the laser beams 238A, 238B may be about 100 micrometers or more, about 200 micrometers or more, about 500 micrometers or more, about 1 millimeters or more, about 2 millimeters or more, about 5 millimeters or more, about 10 millimeters or more, about 30 millimeters or less, about 20 millimeters or less, or about 15 millimeters or less. The molten glass travel path 229 may be perpendicular to the draw direction 154 and parallel to a draw plane 213. In some embodiments, the maximum width of the laser beams 238A, 238B may be in a range from about 100 micrometers to about 30 millimeters, from about 100 micrometers to about 20 millimeters, from about 100 micrometers to about 15 millimeters, from about 200 micrometers to about 30 millimeters, from about 200 micrometers to about 20 millimeters, from about 200 micrometers to about 15 millimeters, from about 500 micrometers to about 30 millimeters, from about 500 micrometers to about 20 millimeters, from about 500 micrometers to about 15 millimeters, from about 1 millimeter to about 30 millimeters, from about 1 millimeter to about 20 millimeters, from about 1 millimeter to about 15 millimeters, from about 2 millimeters to about 30 millimeters, from about 2 millimeters to about 20 millimeters, from about 2 millimeters to about 15 millimeters, from about 5 millimeters to about 30 millimeters, from about 5 millimeters to about 20 millimeters, from about 5 millimeters to about 15 millimeters, from about 10 millimeters to about 30 millimeters, from about 10 millimeters to about 20 millimeters, or from about 15 millimeters to about 20 millimeters. Throughout the disclosure an area of the molten glass 121 impinged by the laser beams 238A, 238B is defined as a portion of the molten glass 121 impinged by the laser beams 238A, 238B with an intensity of about 13.5% (i.e., 1/e²) of a maximum intensity of the laser beams 238A, 238B, where the area is measured at a surface of the molten glass 121 closest to the second ends 237A, 237B of the optical fibers 231A, 231B.

Throughout the disclosure, the power of laser beams 238A, 238B is the average power of the laser beams 238A, 238B transmitted from second ends 237A, 237B of optical fibers 231A, 231B as measured using a thermopile. In some embodiments, a power of the laser beams 238A, 238B may be controlled by controlling optical elements between the laser modules 233A, 233B and the second ends 237A, 237B of the optical fibers 231A, 231B. In some embodiments, a power of the laser beam may be controlled by adjusting the parameters of the laser (e.g., electrical current or voltage, optical pumping conditions). Throughout the disclosure, a power density of each of the laser beams 238A, 238B is the power of the each of the laser beams 238A, 238B divided by the area of the molten glass 121 impinged by the laser beams 238A, 238B, as defined above. In some embodiments, the power density of each of the laser beams 238A, 238B may be up to about 1,500 watts/centimeter² (W/cm²), about 1 W/cm² or more, about 2 W/cm² or more, about 5 W/cm² or more, about 10 W/cm² or more, about 20 W/cm² or more, about 2,000 W/cm² or less, about 1,000 W/cm² or less, about 500 W/cm² or less, about 200 W/cm² or less, about 100 W/cm² or less, or about 50 W/cm² or less. In some embodiments the power density of each of the laser beams 238A, 238B may be in a range from about 1 W/cm² to about 2,000 W/cm², from about 1 W/cm² to about 1,000 W/cm², from about 1 W/cm² to about 500 W/cm², from about 1 W/cm² to about 200 W/cm², from about 1 W/cm² to about 100 W/cm², from about 1 W/cm² to about 50 W/cm², from about 2 W/cm² to about 2,000 W/cm², from about 2 W/cm² to about 1,000 W/cm², from about 2 W/cm² to about 500 W/cm², from about 2 W/cm² to about 200 W/cm², from about 2 W/cm² to about 100 W/cm², from about 2 W/cm² to about 50 W/cm², from about 5 W/cm² to about 2,000 W/cm², from about 5 W/cm² to about 1,000 W/cm², from about 5 W/cm² to about 500 W/cm², from about 5 W/cm² to about 200 W/cm², from about 5 W/cm² to about 100 W/cm², from about 5 W/cm² to about 50 W/cm², from about 10 W/cm² to about 2,000 W/cm², from about 10 W/cm² to about 1,000 W/cm², from about 10 W/cm² to about 500 W/cm², from about 10 W/cm² to about 200 W/cm², from about 10 W/cm² to about 100 W/cm², from about 10 W/cm² to about 50 W/cm², from about 20 W/cm² to about 2,000 W/cm², from about 20 W/cm² to about 1,000 W/cm², from about 20 W/cm² to about 500 W/cm², from about 20 W/cm² to about 200 W/cm², from about 20 W/cm² to about 100 W/cm², or from about 20 W/cm² to about 50 W/cm².

Throughout the disclosure, a target location is defined as a location to be impinged by a laser beam. Referring to FIG. 2B, first target locations 232A, 232A′ on the molten glass 121 may be defined as the location where the laser beams 238A, 238B impinge on a portion of the molten glass 121 as it travels along the molten glass travel path 229. In some embodiments, as shown in FIGS. 2A-2B, the first target locations 232A, 232A′ on the molten glass 121 may be above the root 145 of the glass forming body 140. In further embodiments, the laser beams 238A, 238B may impinge on a portion of the inclined converging surface portion 207A of the glass forming body 140 at a second target location 232B, 232B′ on a surface of the glass forming body 140. In some embodiments, it may be desirable for the first target locations 232A, 232A′ to be above the root 145 of the glass forming body 140 because the molten glass 121 typically moves slower than the molten glass 121 below the root 145, which means that a portion of the molten glass 121 may be impinged by the laser beams 238A, 238B longer when the first target locations 232A, 232A′ are above the root 145 than if the first target locations 232A, 232A′ are below the root 145. Further, it may be desirable for the first target locations 232A, 232A′ to be above the root 145 of the glass forming body 140 to correct a deviation in a thickness of a portion of the molten glass 121 that is specific to the corresponding side of the glass forming body 140. For example, one of the weirs 203A, 203B of the glass forming body 140 may comprise an imperfection that produces a “streak” where the molten glass is thicker than desired, and heating the molten glass 121 on the corresponding side of the glass forming body 140 at the outer surface 205A, 205B and/or the inclined converging surface portions 207A, 207B may ameliorate this “streak” before the molten glass 121 converges at the root 145 and is drawn. Still further, it may be beneficial in some embodiments to provide the first target locations 232A, 232A′ above the root 145 to allow energy passing through the molten glass to be captured by the forming vessel at the second target location 232B, 232B′. As such, the forming vessel may be heated further at the second target location 232B, 232B′ and/or the laser beam may be reflected from the forming vessel to further heat the portion of the molten glass traveling over the second target location 232B, 232B′ while being directly heated by the laser beams 238A, 238B at the first target locations 232A, 232A′. Consequently, heating efficiency of heating the desired location of the molten glass may be achieved in some embodiments by simultaneously directly heating the molten glass 121 at the first target locations 232A, 232A′ with the laser beams 238A, 238B while also further indirectly heating the molten glass 121 with the portion of the forming vessel heated by the laser beams 238A, 238B and/or reflecting the laser beam from the forming vessel at the second target location 232B, 232B′. In other embodiments, the laser beams 238A, 238B may impinge a portion of the molten glass 121 at a target location on the molten glass 121 as it travels along the molten glass travel path 229 below the root 145 of the glass forming body 140. Where the laser beams 238A, 238B impinge a portion of the molten glass 121 at a target location on the molten glass 121 that is below the root 145, the spatial resolution may be improved relative to other embodiments where laser beams 238A, 238B impinge at a target location above the root 145. Additionally, where the target location is below the root 145, this may result in a more uniform change in thickness on both sides of the molten glass 121. As compared to embodiments where the target location for laser beams 238A, 238B is below the root 145, embodiments that set the target location for laser beams 238A, 238B above the root 145 may result in reduced resolution due to thermal conduction in the glass forming body 140.

In some embodiments, as shown in FIG. 2B, the laser beam 238A of the first heating apparatus 226A may be parallel with the laser beam 238B of the second heating apparatus 226B. In other embodiments, although not shown, the laser beam 238A of the first heating apparatus 226A may not be parallel with the laser beam 238B of the second heating apparatus 226B. In some embodiments, as shown in FIG. 2B, the laser beam 238A of the first heating apparatus 226A and the laser beam 238B of the second heating apparatus 226B may impinge on portions of the molten glass 121 that may be at the same elevational position on the draw plane 213. In other embodiments, the laser beam 238A of the first heating apparatus 226A and the laser beam 238B of the second heating apparatus 226B may impinge on portions of the molten glass 121 that may be at different elevational positions on the draw plane 213. It is to be understood that any of the arrangements of the laser beam 238A of the first heating apparatus 226A may be parallel with the laser beam 238B of the second heating apparatus 226B may be used in combination with embodiments where the first target locations 232A, 232A′ are above the root 145 of the glass forming body 140, the target location is below the root of the forming vessel, or a hybrid of these embodiments where the laser beam 238A of the first heating apparatus 226A impinges a first target location 232A above the root 145 of the glass forming body 140 and the laser beam 238B of the second heating apparatus 226B impinges a target location below the root 145 of the forming vessel.

Throughout the disclosure, an angle of incidence is defined as an angle formed by an intersection of a plane defined by a face of a molten glass 121 at the first target location 232A, 232A′ closest to a second ends 237A, 237B of optical fibers 231A, 231B and a line running through a center of the second ends 237A, 237B of the optical fiber and a center of the first target location 232A, 232A′ of the molten glass 121 on the molten glass travel path 229. In some embodiments, the angle of incidence may be about 70 degrees or more, about 80 degrees or more, about 85 degrees or more, about 88 degrees or more, about 90 degrees, about 110 degrees or less, 100 degrees or less, about 95 degrees or less, about 92 degrees or less, or about 90 degrees. In some embodiments, the angle of incidence may be in a range from about 70 degrees to about 110 degrees, from about 80 degrees to about 100 degrees, from about 85 degrees to about 95 degrees, from about 88 degrees to about 92 degrees. Throughout the disclosure an angle of incidence may be considered “about normal” when it is in a range from about 80 degrees to about 100 degrees, from about 85 degrees to about 95 degrees, from about 88 degrees to about 92 degrees, or about 90 degrees. In some embodiments, each of the passages 236A, 236B may be inclined to make the angle of incidence about normal when the first target location 232A, 232A′ is above the root 145 of the glass forming body 140.

The molten glass 121 may comprise an absorption depth at a wavelength of the laser beams 238A, 238B. Throughout the disclosure, an absorption depth of a material is defined as thickness of the material at which an intensity (e.g., power, power density) of laser beams 238A, 238B decreases to 36.8% (i.e., 1/e) of an initial intensity of the laser beams 238A, 238B. Without wishing to be bound by theory, it is possible to estimate the absorption depth using the Beer-Lambert law, which predicts that intensity decreases exponentially with the thickness of the material divided by the absorption depth. For some materials, the absorption depth may change with temperature. Unless otherwise specified, absorption depth was measured at about 1000 degrees Celsius. In some embodiments, the molten glass 121 may comprise an absorption depth at a wavelength of the laser beams 238A, 238B of about 200 micrometers or less, about 150 micrometers or less, about 125 micrometers or less, about 100 micrometers or less, about 75 micrometers or less, about 50 micrometers or less, or about 25 micrometers or less. It may be desirable for the absorption depth to be greater than the thickness of the molten glass so that the entirety of the molten glass in the portion where the laser beams 238A, 238B impinge is heated by the laser beams 238A, 238B.

The glass manufacturing apparatus 100 comprising laser modules 233A, 233B and optical fibers 231A, 231B as described herein may be used in a method of manufacturing glass. First, molten glass 121 may flow from the glass forming body 140 along the molten glass travel path 229. Then, laser beams 238A, 238B may be transmitted from the laser modules 233A, 233B into the first ends 239A, 239B of the optical fibers 231A, 231B. The laser beams 238A, 238B may propagate along the optical fibers 231A, 231B from the first ends 239A, 239B of the optical fibers 231A, 231B to the second ends 237A, 237B of the optical fibers 231A, 231B. Further, the laser beams 238A, 238B may be transmitted from the second ends 237A, 237B of the optical fibers 231A, 231B toward the molten glass travel path 229. Then, the laser beams 238A, 238B may impinge first target location 232A, 232A′ while molten glass 121 is flowing along the molten glass travel path 229. The laser beams 238A, 238B may heat a portion of the molten glass 121 that is at the first target locations 232A, 232A′. The laser beams 238A, 238B may also decrease a viscosity of a portion of the molten glass 121 that is at the first target locations 232A, 232A′. In some embodiments, the first target locations 232A, 232A′ may be chosen by determining a portion of the molten glass 121 comprising a thickness with a deviation from a predefined thickness, where the deviation is greater than a predetermined threshold. As such, heating the first target locations 232A, 232A′ may be achieved by impinging the laser beams 238A, 238B at the first target locations 232A, 232A′ to reduce a viscosity of the portion of the molten glass 121 at the target location which may reduce the deviation of the thickness of the portion of the molten glass 121 from the predefined thickness.

In some embodiments, the target location of the molten glass 121 may be below the root 145 of the glass forming body 140. Consequently, a portion of the molten glass 121 may comprise a glass ribbon 103 (see FIGS. 1, 2A-2B) at the target location, and the laser beams 238A, 238B may heat the portion of the molten glass 121 comprising the glass ribbon 103 (see FIGS. 1, 2A-2B). In other embodiments, as illustrated in FIG. 2B, the first target locations 232A, 232A′ may be above the root 145 of the glass forming body 140. In further embodiments, the laser beams 238A, 238B may heat a surface portion (e.g., a portion of the inclined converging surface portions 207A, 207B) of the glass forming body 140 at the second target location 232B, 232B′ in addition to the first target locations 232A, 232A′ of the molten glass 121. In even further embodiments, a portion of the laser beams 238A, 238B may reflect off the surface portion (e.g., a portion of the inclined converging surface portions 207A, 207B) of the glass forming body 140 at the second target locations 232B, 232B′ to heat the portion of molten glass 121 at the first target locations 232A, 232A′ again. However, in some embodiments such as where carbon dioxide lasers are utilized to form laser beams, the absorption depth may be short, and a minimal amount of laser power may reach the glass forming body 140. Additionally, in some embodiments, the glass forming body 140 may absorb laser power and convert it into heat, which results in the transfer of further heat to the molten glass 121 as portions adjacent to the inclined converging surface portions 207A, 207B.

In some embodiments, optical elements may be used to redirect a laser beam from a laser module. FIG. 2C is a schematic view illustrating an example optical element being used to redirect a laser beam from a laser module towards a face of molten glass. The optical element in FIG. 2C is a reflecting apparatus 248, which is included as part of a control apparatus 210. However, the optical element may take other forms such as a lens, a refractive element, etc. The reflecting apparatus 248 includes one or more reflecting surfaces 214. The laser module 233C is configured to generate a laser beam 213A, and this laser beam 213A is directed towards the reflecting apparatus 248. The reflecting apparatus 248 is configured to reflect the laser beam 213A generated and emitted by the laser module 233C onto a portion of the face 215A of the molten glass 121. The reflecting apparatus 248 may therefore function as a beam-steering and/or scanning device. In FIG. 2C, the laser beam 213A is illustrated as being advanced as reflected laser beams 217 to a plurality of preselected portions of the face 215A of the molten glass 121 as a result of incremental adjustments of the attitude of the reflecting surface 214 made with respect to the receipt of the laser beam 213A by the reflecting surface 214 and the locations of the face 215A of the molten glass 121. It is noted here, however, that thickness variations that may occur with respect to glass substrates may be localized such that the thickness variations exist in a very small, localized area. Because the laser beam spot striking the glass substrate also is very small, localized thickness variations may be addressed without affecting immediately adjacent portions of the glass substrate. Thus, the laser beams may provide localized heating at high spatial resolutions.

The reflecting apparatus 248 in the embodiment illustrated in FIG. 2C also includes a regulating mechanism 252 configured to adjust an attitude of the reflecting surface 214 of the reflecting apparatus 248 with respect to the receipt of the laser beam 213A and a location of the face 215A of the molten glass 121 in a viscous state. Thereby, the laser beam 213A may be reflected as reflected laser beams 217 from the reflecting surface 214 onto the at least one preselected portion of the glass substrate. According to one example, the regulating mechanism 252 may comprise a galvanometer that is operatively associated with the reflecting surface 214 so that the reflecting surface 214 may be rotated by the galvanometer along an axis in relation to the face 215A. For example, the reflecting surface 214 may be mounted on a rotating shaft 250 that is driven by a galvanometer motor and rotated about axis Δ1 as shown by double arrow 219.

As illustrated in the embodiment of FIG. 2C, the reflecting apparatus 248 is located with respect to the molten glass 121 such that the laser beam 213A may be directed from the reflecting surface 214 of the reflecting apparatus 248 onto at least one preselected portion of the face 215A of the molten glass 121 in a viscous state prior to the thickness of the at least one preselected portion of the glass ribbon becoming fixed. In the embodiment of FIG. 2C, the reflected laser beams 217 are directed to the molten glass 121 below the root 145 (see FIG. 2A). The reflected laser beams 217 may be scanned across width W of the molten glass 121 continuously, and the laser beams 217 may travel across the glass at a constant linear speed in some embodiments. As reflected laser beams 217 are scanned across the width W, the power level may vary at different positions based on a power profile utilized at the laser module 233C. The reflected laser beams 217 may be scanned by rotating the reflecting surface 214, but the reflected laser beams 217 may also be scanned without rotating the reflecting surface 214 by shifting the direction of laser beam 213A relative to the reflecting surface 214. Where scanning is accomplished by rotating the reflecting surface 214, changes in the amount of laser power applied may be synchronized with the motion of the reflecting surface 214. An increased amount of laser power may be used for locations on the molten glass 121 where the thickness is too large, and a reduced amount of laser power may be used for locations on the molten glass 121 where the thickness is smaller. Thus, the reflected laser beams 217 are directed to a location where the separate flows of molten glass 121 flowing along the inclined converging surface portions 207A, 207B (see FIG. 2A) have converged to form a glass ribbon in a viscous state. During scanning, the reflected laser beams 217 are directed to a location where the thickness of the glass ribbon has still not been fixed. However, the reflected laser beams 217 need not be directed to the glass ribbon below the root 145 and may be directed to positions above the root. Laser beams may be directed to contact a contact area on the molten glass 121, and the “impact area” is defined as the area that is affected by the laser beam, with this impact area potentially being larger than the contact area. While the laser beams may contact a specific contact area, the surrounding areas around the contact area may also be heated to increased temperatures so that the overall impact area is greater than the contact area. By increasing the temperature and reducing the viscosity of a preselected portion of the glass substrate at a location at which the preselected portion of the glass substrate is in a viscous state and its thickness has not been fixed, the preselected portion of the glass substrate will tend to flow, under the influence, for example, of thermo-mechanical and other forces present at the preselected portion of the glass substrate, so that the thickness of the preselected portion of the glass substrate will have a desired thickness at that preselected portion of the glass substrate.

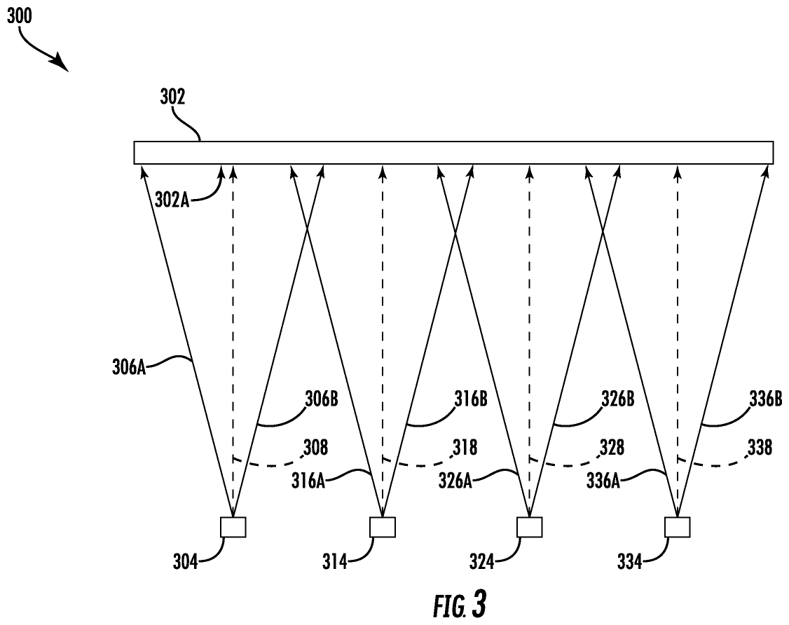

Various mounting approaches may be utilized for laser modules, and FIGS. 3-8 illustrate some example mounting approaches. The mounting angle for laser modules may be adjusted to different tilt angles relative to a direction normal to the molten glass face. As used herein, the “tilt angle” is the difference in an angle that is parallel to the centerline for the scanning field of a laser module relative to an angle that is normal to a face of the molten glass. Increasing the tilt angle of a laser module increases the coverage length for that laser module, allowing a width of the molten glass ribbon to be covered using a lower number of laser modules. By using a lower number of laser modules, significant cost savings may be accomplished. Additionally, where a lower number of laser modules are used, areas proximate to the molten glass may be made less congested. Where less laser modules are required, the cost of forming the system may be significantly reduced. Angles of each laser module may be unique, and spacing between modules may or may not be uniform. Angles may be selected to optimize performance for a particular ribbon width and/or glass forming mechanism access. In some embodiments, a single module may not be optimal for covering the width of the ribbon. The overall laser power necessary to generate a thickness correction across the width of the ribbon may prohibit the use of a single module. For example, the laser may physically be too big, and this may make it too complex to cool the optics and too difficult to focus across a large scan angle on the glass.

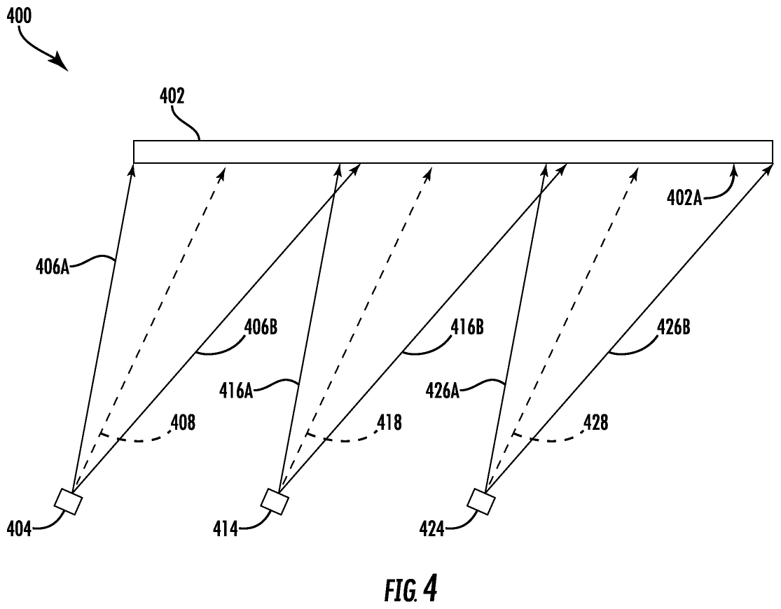

An example system 300 is illustrated in FIG. 3 with a mounting approach for four laser modules to cover a 3.5 meter length of the molten glass 302 in the width direction. While the molten glass 302 and the molten glass in FIGS. 4-8 have a 3.5 meter length in the width direction, molten glass may have other lengths in the width direction, and the 3.5 meter length was selected merely for the purposes of explanation. The molten glass 302 defines a face 302A. A first laser module 304 emits a first laser beam extending between a first extreme direction 306A and the second extreme direction 306B, with the first laser beam having a central direction 308 between the first extreme direction 306A and a second extreme direction 306B. The central direction 308 has a central strike angle that is measured relative to a normal of the face 302A of the molten glass 302, with this central strike angle being equal to zero degrees. A first scan angle range of the first laser module 304 is the difference of the scan angle at the second extreme direction 306B and the scan angle at the first extreme direction 306A, and this first scan angle range may be greater than about 40 degrees in some embodiments. Where a beam steering system 248 (see FIG. 2C) is utilized, the scan angle range may be measured from the reflective surface 214 (see FIG. 2C) of the beam steering system 248.

A second laser module 314 emits a second laser beam extending between a first extreme direction 316A and a second extreme direction 316B, with the second laser beam having a central direction 318 between the first extreme direction 316A and the second extreme direction 316B. The central direction 318 has a central strike angle that is measured relative to a normal of the face 302A of the molten glass 302, with this central strike angle being equal to zero degrees. A second scan angle range of the second laser module 314 is the difference of the scan angle at the second extreme direction 316B and the scan angle at the first extreme direction 316A, and this second scan angle range may be greater than about 40 degrees in some embodiments.

A third laser module 324 emits a third laser beam extending between a first extreme direction 326A and the second extreme direction 326B, with the third laser beam having a central direction 328 between the first extreme direction 326A and a second extreme direction 326B. The central direction 328 has a central strike angle that is measured relative to a normal of the face 302A of the molten glass 302, with this central strike angle being equal to zero degrees. A third scan angle range of the third laser module 324 is the difference of the scan angle at the second extreme direction 326B and the scan angle at the first extreme direction 326A, and this third scan angle range may be greater than about 40 degrees in some embodiments.

A fourth laser module 334 emits a fourth laser beam extending between a first extreme direction 336A and a second extreme direction 336B, with the fourth laser beam having a central direction 338 between the first extreme direction 336A and the second extreme direction 336B. The central direction 338 has a central strike angle that is measured relative to a normal of the face 302A of the molten glass 302, with this central strike angle being equal to zero degrees. A fourth scan angle range of the fourth laser module 334 is the difference of the scan angle at the second extreme direction 336B and the scan angle at the first extreme direction 336A, and this fourth scan angle range may be greater than about 40 degrees in some embodiments.

Additionally, each of the laser modules 304, 314, 324, 334 have a 0 degree module tilt angle relative to the normal of the face 302A of the molten glass 302. The module tilt angle may match the central strike angle for a module where no optical element (e.g., reflecting apparatus such as a galvo) is used to redirect a laser beam. With each of the central strike angles being about zero degrees, full coverage of the 3.5 meter length of molten glass 302 may not be accomplished with three laser modules without adjusting the distance of the laser modules relative to the molten glass 302 or without increasing the scan angle range for each module.

Another example system 400 is illustrated in FIG. 4 with one mounting approach for three laser modules. The laser modules are each directed at molten glass 402 that is 3.5 meters long in the width direction. The molten glass 402 defines a face 402A. A first laser module 404 emits a first laser beam extending between a first extreme direction 406A and the second extreme direction 406B, with the first laser beam having a central direction 408 between the first extreme direction 406A and a second extreme direction 406B. The central direction 408 has a central strike angle that is measured relative to a normal of the face 402A of the molten glass 402, with this central strike angle being equal to about 30 degrees. A first scan angle range of the first laser module 404 is the difference of the scan angle at the second extreme direction 406B and the scan angle at the first extreme direction 406A, and this first scan angle range may be greater than about 40 degrees in some embodiments.

A second laser module 414 emits a second laser beam extending between a first extreme direction 416A and a second extreme direction 416B, with the second laser beam having a central direction 418 between the first extreme direction 416A and the second extreme direction 416B. The central direction 418 has a central strike angle that is measured relative to a normal of the face 402A of the molten glass 402, with this central strike angle being equal to about 30 degrees. A second scan angle range of the second laser module 414 is the difference of the scan angle at the second extreme direction 416B and the scan angle at the first extreme direction 416A, and this second scan angle range may be greater than about 40 degrees in some embodiments.

A third laser module 424 emits a third laser beam extending between a first extreme direction 426A and the second extreme direction 426B, with the third laser beam having a central direction 428 between the first extreme direction 426A and a second extreme direction 426B. The central direction 428 has a central strike angle that is measured relative to a normal of the face 402A of the molten glass 402, with this central strike angle being equal to about 30 degrees. A third scan angle range of the third laser module 424 is the difference of the scan angle at the second extreme direction 426B and the scan angle at the first extreme direction 426A, and this third scan angle range may be greater than about 40 degrees in some embodiments. Each of the laser modules 404, 414, 424 have a 30 degree module tilt angle relative to the normal of the face 402A of the molten glass 402.

With each of the central strike angles being about 30 degrees, full coverage of the 3.5 meter length of molten glass 402 may be accomplished with three laser modules. By contrast, with central strike angles of zero degrees, full coverage of the 3.5 meter length of molten glass requires at least four laser modules as illustrated in FIG. 3.

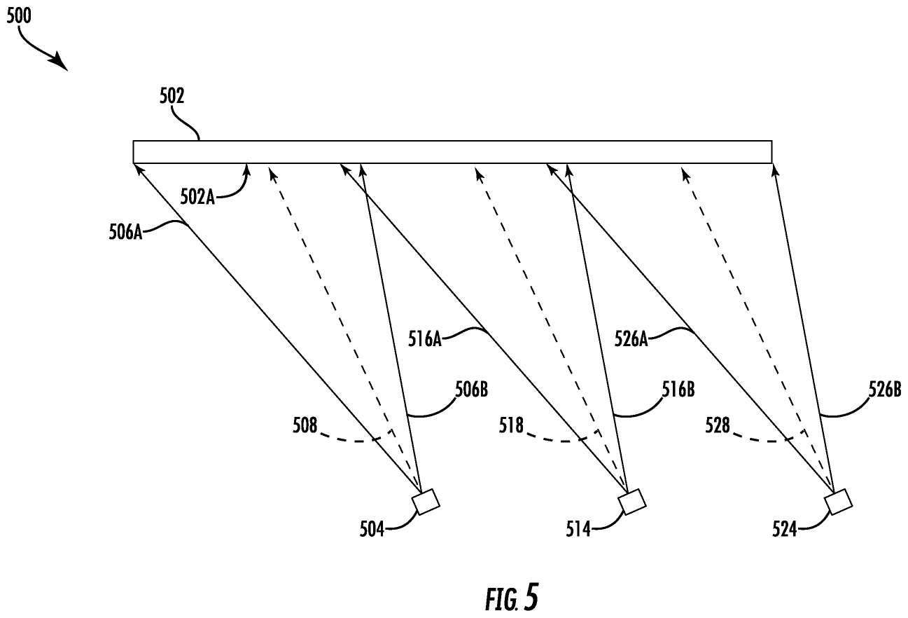

Another example system 500 is illustrated in FIG. 5 with another mounting approach for three laser modules. The laser modules are each directed at molten glass 502 that is 3.5 meters long in the width direction. The molten glass 502 defines a face 502A. A first laser module 504 emits a first laser beam extending between a first extreme direction 506A and the second extreme direction 506B, with the first laser beam having a central direction 508 between the first extreme direction 506A and a second extreme direction 506B. The central direction 508 has a central strike angle that is measured relative to a normal of the face 502A of the molten glass 502, with this central strike angle being equal to about −30 degrees. A first scan angle range of the first laser module 504 is the difference of the scan angle at the second extreme direction 506B and the scan angle at the first extreme direction 506A, and this first scan angle range may be greater than about 40 degrees in some embodiments.

A second laser module 514 emits a second laser beam extending between a first extreme direction 516A and a second extreme direction 516B, with the second laser beam having a central direction 518 between the first extreme direction 516A and the second extreme direction 516B. The central direction 518 has a central strike angle that is measured relative to a normal of the face 502A of the molten glass 502, with this central strike angle being equal to about −30 degrees. A second scan angle range of the second laser module 514 is the difference of the scan angle at the second extreme direction 516B and the scan angle at the first extreme direction 516A, and this second scan angle range may be greater than about 40 degrees in some embodiments.

A third laser module 524 emits a third laser beam extending between a first extreme direction 526A and the second extreme direction 526B, with the third laser beam having a central direction 528 between the first extreme direction 526A and a second extreme direction 526B. The central direction 528 has a central strike angle that is measured relative to a normal of the face 502A of the molten glass 502, with this central strike angle being equal to about-30 degrees. A third scan angle range of the third laser module 524 is the difference of the scan angle at the second extreme direction 526B and the scan angle at the first extreme direction 526A, and this third scan angle range may be greater than about 40 degrees in some embodiments. Each of the laser modules 504, 514, 524 have a −30 degree module tilt angle relative to the normal of the face 502A of the molten glass 502.

With the −30 degree central strike angles, full coverage of the 3.5 meter length of molten glass 502 may be accomplished with three laser modules. By contrast, with central strike angles of zero degrees, full coverage of the 3.5 meter length of molten glass requires at least four laser modules as illustrated in FIG. 4.

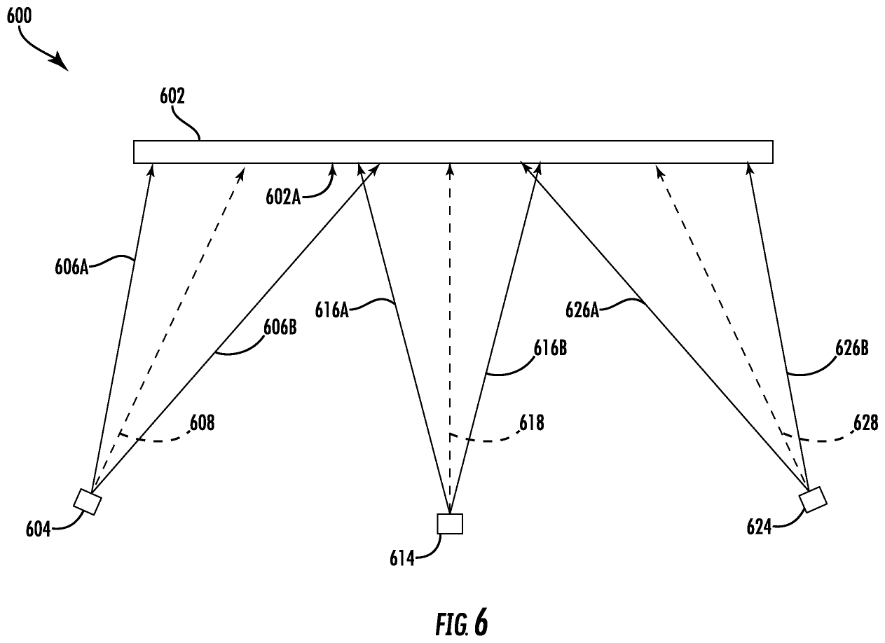

Another example system 600 is illustrated in FIG. 6 with another mounting approach for three laser modules with different central strike angles for laser beams that are generated by each of the laser modules. The laser modules are each directed at molten glass 602 that is 3.5 meters long in the width direction. The molten glass 602 defines a face 602A. A first laser module 604 emits a first laser beam extending between a first extreme direction 606A and the second extreme direction 606B, with the first laser beam having a central direction 608 between the first extreme direction 606A and a second extreme direction 606B. The central direction 608 has a central strike angle that is measured relative to a normal of the face 602A of the molten glass 602, with this central strike angle being equal to about 30 degrees. The first laser module 604 has a module tilt angle of about 30 degrees relative to a normal of the face 602A. A first scan angle range of the first laser module 604 is the difference of the scan angle at the second extreme direction 606B and the scan angle at the first extreme direction 606A, and this first scan angle range may be greater than about 40 degrees in some embodiments.

A second laser module 614 emits a second laser beam extending between a first extreme direction 616A and a second extreme direction 616B, with the second laser beam having a central direction 618 between the first extreme direction 616A and the second extreme direction 616B. The central direction 618 has a central strike angle that is measured relative to a normal of the face 602A of the molten glass 602, with this central strike angle being equal to about zero degrees. The second laser module 614 has a module tilt angle of about zero degrees relative to a normal of the face 602A. A second scan angle range of the second laser module 614 is the difference of the scan angle at the second extreme direction 616B and the scan angle at the first extreme direction 616A, and this second scan angle range may be greater than about 40 degrees in some embodiments.

A third laser module 624 emits a third laser beam extending between a first extreme direction 626A and the second extreme direction 626B, with the third laser beam having a central direction 628 between the first extreme direction 626A and a second extreme direction 626B. The central direction 628 has a central strike angle that is measured relative to a normal of the face 602A of the molten glass 602, with this central strike angle being equal to about −30 degrees. The third laser module 624 has a module tilt angle of about −30 degrees relative to a normal of the face 602A. A third scan angle range of the third laser module 624 is the difference of the scan angle at the second extreme direction 626B and the scan angle at the first extreme direction 626A, and this third scan angle range may be greater than about 40 degrees in some embodiments.

When the laser modules 604, 614, 624 are mounted in the manner illustrated in FIG. 6, full coverage of the 3.5 meter length of molten glass 602 may again be accomplished with three laser modules. Additionally, with the mounting approach of FIG. 6, there may be less energy loss at the center of the face 602A where the second laser beam generated by the second laser module 614 strikes the molten glass 602. Energy loss may be lower at the center of the face 602A relative to areas near the edges of the face 602A as laser beams generated by the laser modules 604, 624 may generally be required to travel greater distances to reach the face 602A, resulting in less laser power reaching the face 602A.

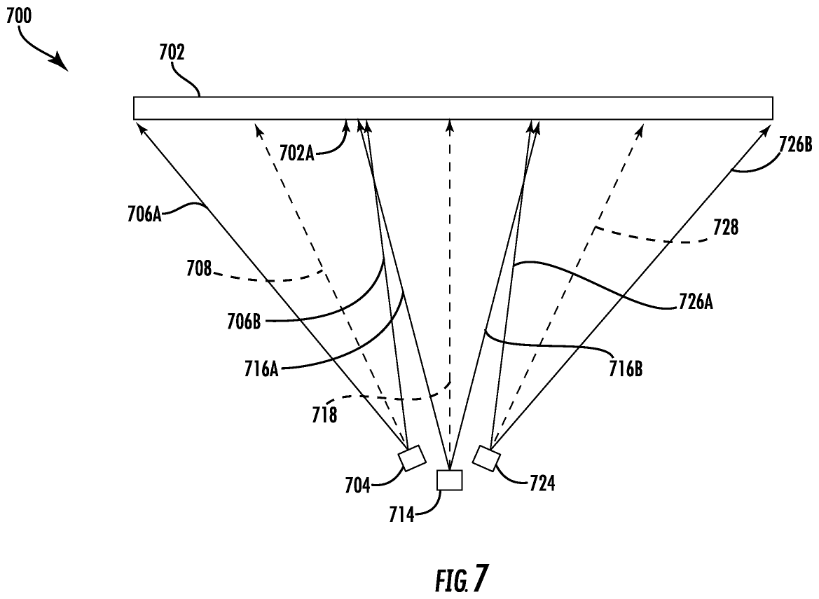

Another example system 700 is illustrated in FIG. 7 with another mounting approach for three laser modules. The laser modules are each directed at molten glass 702 that is 3.5 meters long in the width direction. The molten glass 702 defines a face 702A. A first laser module 704 emits a first laser beam extending between a first extreme direction 706A and the second extreme direction 706B, with the first laser beam having a central direction 708 between the first extreme direction 706A and a second extreme direction 706B. The central direction 708 has a central strike angle that is measured relative to a normal of the face 702A of the molten glass 702, with this central strike angle being equal to about −30 degrees. The first laser module 704 has a module tilt angle of about −30 degrees relative to a normal of the face 702A. A first scan angle range of the first laser module 704 is the difference of the scan angle at the second extreme direction 706B and the scan angle at the first extreme direction 706A, and this first scan angle range may be greater than about 40 degrees in some embodiments.

A second laser module 714 emits a second laser beam extending between a first extreme direction 716A and a second extreme direction 716B, with the second laser beam having a central direction 718 between the first extreme direction 716A and the second extreme direction 716B. The central direction 718 has a central strike angle that is measured relative to a normal of the face 702A of the molten glass 702, with this central strike angle being equal to about zero degrees. The second laser module 714 has a module tilt angle of about zero degrees relative to a normal of the face 702A. A second scan angle range of the second laser module 714 is the difference of the scan angle at the second extreme direction 716B and the scan angle at the first extreme direction 716A, and this second scan angle range may be greater than about 40 degrees in some embodiments.

A third laser module 724 emits a third laser beam extending between a first extreme direction 726A and the second extreme direction 726B, with the third laser beam having a central direction 728 between the first extreme direction 726A and a second extreme direction 726B. The central direction 728 has a central strike angle that is measured relative to a normal of the face 702A of the molten glass 702, with this central strike angle being equal to about 30 degrees. The third laser module 724 has a module tilt angle of about 30 degrees relative to a normal of the face 702A. A third scan angle range of the third laser module 724 is the difference of the scan angle at the second extreme direction 726B and the scan angle at the first extreme direction 726A, and this third scan angle range may be greater than about 40 degrees in some embodiments.

When the laser modules 704, 714, 724 are mounted in the manner illustrated in FIG. 7, full coverage of the 3.5 meter length of molten glass 702 may again be accomplished with three laser modules. Additionally, with the mounting approach of FIG. 7, there may be less energy loss at the center of the face 702A where the second laser beam generated by the second laser module 714 strikes the face 702A. Furthermore, for the first laser beam generated by the first laser module 704 and the third laser beam generated by the third laser module 724, the energy loss at areas more proximate to the central part of the face 702A may be lower and the energy loss at areas more proximate to the extreme ends of the face 702A may be increased as the laser beams are required to travel greater distances to these extreme ends of the molten glass 702. With the mounting approach illustrated in FIG. 7, the center region (e.g., from left to right in FIG. 7) of the molten glass 702 may experience greater accuracy in the thickness control relative to other region of the molten glass 702.

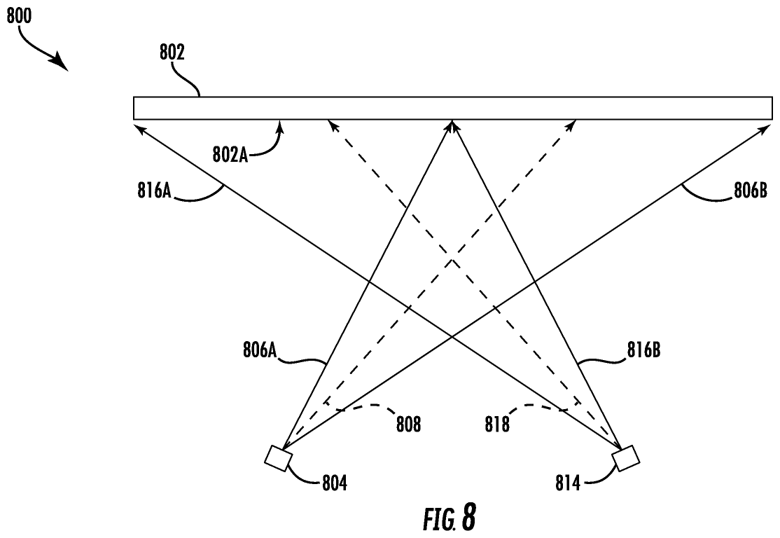

Another example system 800 is illustrated in FIG. 8 with another mounting approach for two laser modules. The laser modules are each directed at molten glass 802 that is 3.5 meters long in the width direction. The molten glass 802 defines a face 802A. A first laser module 804 emits a first laser beam extending between a first extreme direction 806A and the second extreme direction 806B, with the first laser beam having a central direction 808 between the first extreme direction 806A and a second extreme direction 806B. The central direction 808 has a central strike angle that is measured relative to a normal of the face 802A of the molten glass 802, with this central strike angle being equal to about 45 degrees. The first laser module 804 has a module tilt angle of about 45 degrees relative to a normal of the face 802A. A first scan angle range of the first laser module 804 is the difference of the scan angle at the second extreme direction 806B and the scan angle at the first extreme direction 806A, and this first scan angle range may be greater than about 40 degrees in some embodiments.

A second laser module 814 emits a second laser beam extending between a first extreme direction 816A and a second extreme direction 816B, with the second laser beam having a central direction 818 between the first extreme direction 816A and the second extreme direction 816B. The central direction 818 has a central strike angle that is measured relative to a normal of the face 802A of the molten glass 802, with this central strike angle being equal to about −45 degrees. The second laser module 814 has a module tilt angle of about −45 degrees relative to a normal of the face 802A. A second scan angle range of the second laser module 814 is the difference of the scan angle at the second extreme direction 816B and the scan angle at the first extreme direction 816A, and this second scan angle range may be greater than about 40 degrees in some embodiments.

When the laser modules 804, 814 are mounted in the manner illustrated in FIG. 8, full coverage of the 3.5 meter length of molten glass 802 may be accomplished with two laser modules. Furthermore, for the first laser beam generated by the first laser module 804 and the second laser beam generated by the second laser module 814, the energy loss at areas more proximate to the central part of the face 802A may be lower and the energy loss at areas more proximate to the extreme ends of the face 802A may be increased as the laser beams are required to travel greater distances to these extreme ends of the face 802A. With this mounting approach, the center region (e.g., from left to right in FIG. 8) of the face 802A will experience greater accuracy in the thickness control relative to other region of the face 802A.

In some of the systems 300, 400, 500, 600, 700, 800, there is an overlap between laser beams generated by adjacent laser modules. For example, in system 300 of FIG. 3, the first laser beam generated by the first laser module 304 and the second laser beam generated by the second laser module 314 overlap with each other. Where this is the case, the angular range of one of the laser modules may be precisely adjusted to effectively turn off energy output in the overlap region so that areas on a face of the molten glass within the overlap region are not contacted by multiple laser beams. This may be beneficial to avoid thickness deviations at locations covered by multiple laser beams. In alternative embodiments, the energy output in the overlap region may be adjusted for each laser module so as to arrive at the desired energy output at the location (e.g., a first laser module may supply 20% of the desired energy output, while the second laser module may supply the remaining 80% of the desired energy output—although any variation thereof is contemplated).

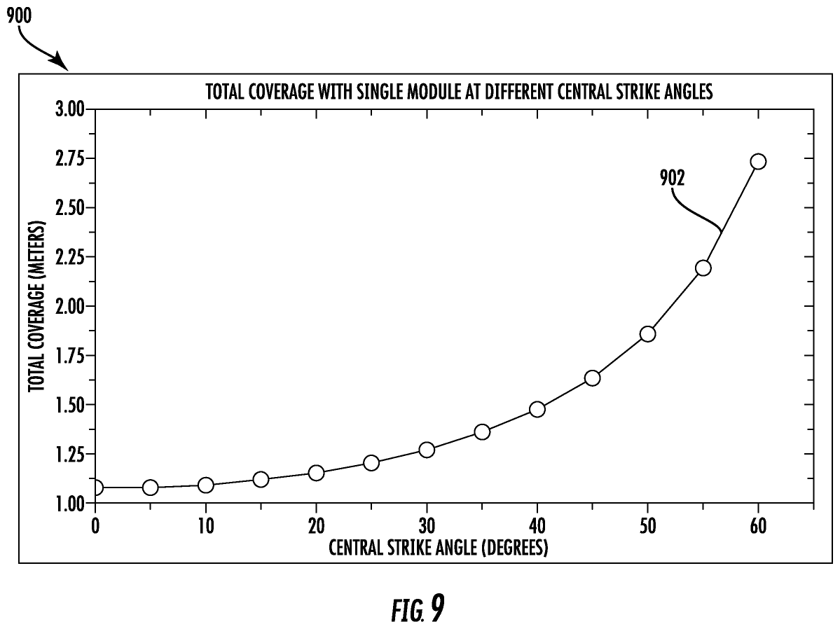

As illustrated in FIGS. 3-8, an increase in the absolute value of central strike angles of a laser module increases the coverage at a face of the molten glass. FIG. 9 is a line graph 900 illustrating the coverage of a face of molten glass by a single module when different module tilt angles and different central strike angles are used. For the results illustrated in the line graph 900, the distance between the module and the glass remained constant as the central strike angle changed. Additionally, for the results illustrated in the line graph 900, the scan angle range remained constant as the central strike angle changed. The plotline 902 begins at a total coverage of around 1.10 meters at a zero degree central strike angle. The plotline 902 increases to a total coverage of around 1.125 meters at a 15 degree central strike angle. The total coverage rises further to around 1.25 meters at a 30 degree central strike angle. The plotline 902 increases to a total coverage of around 1.50 meters at a 40 degree central strike angle. The total coverage rises further to around 1.875 meters at a 50 degree central strike angle. The plotline 902 increases even further to a total coverage of around 2.75 meters at a 60 degree central strike angle. The plotline 902 gradually increases as the central strike angle is increased from zero degrees to around 30 degrees, but the plotline increases at a higher rate as the central strike angle is increased further beyond 30 degrees. While the increases in the central strike angles to angles larger than around 50 degrees results in even greater coverage levels, the incident beam enters the molten glass at a grazing incidence when the central strike angle increases beyond around 50 degrees. Thus, the optimal central strike angle may be selected while considering the coverage and performance levels required. The line graph 900 is summarized in Table 1 below.

TABLE 1
Impact of Central Strike Angle on Coverage

| | | Percentage Increase in |
|---|---|---|
| | | Coverage Relative to |
| Central Strike | | Module with a Central |
| Angle | Coverage | Strike Angle of |
| (degrees) | (meters) | Zero |
| 0 | 1.10 | 0% |
| 15 | 1.125 | 2.27% |
| 30 | 1.25 | 13.64% |
| 40 | 1.5 | 36.36% |
| 50 | 1.875 | 70.45% |
| 60 | 2.75 | 150.00% |

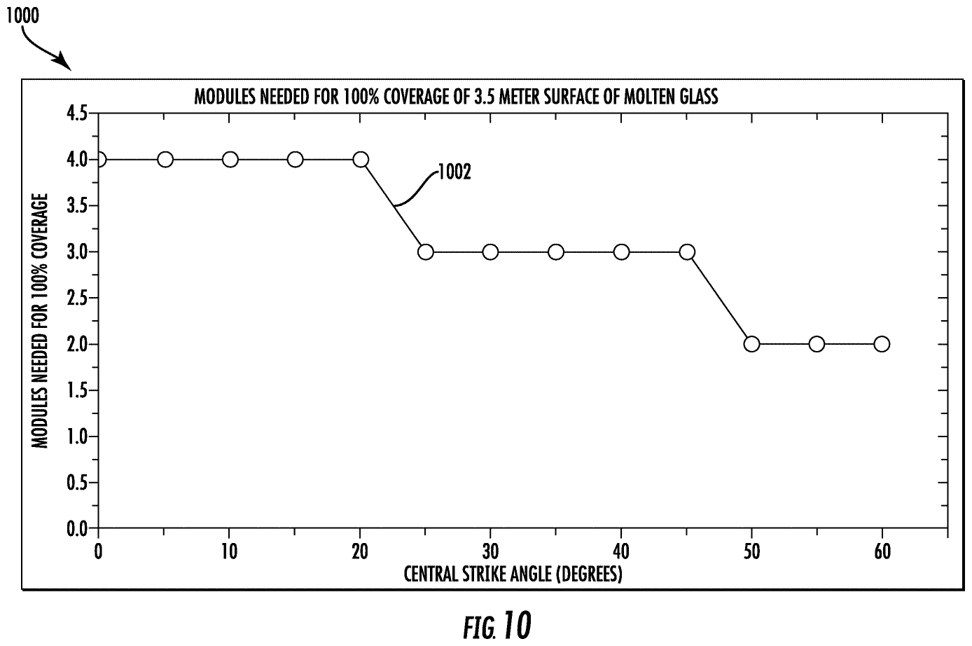

FIG. 10 is a line graph 1000 illustrating a plotline 1002 for the number of modules needed to obtain full coverage of a 3.5 meter length of molten glass when various central strike angles are used. When the central strike angle is between zero degrees and 20 degrees, at least four laser modules are required to obtain full coverage of the 3.5 meter length of molten glass. The number of laser modules required to obtain full coverage may be reduced as the central strike angles for the laser modules are increased. At central strike angles between 25 degrees and 45 degrees, three laser modules are required to obtain full coverage of the 3.5 meter length of molten glass. At central strike angles between 50 degrees and 60 degrees, two laser modules are required to obtain full coverage of the 3.5 meter length of molten glass.

In the line graph 1000 of FIG. 10, the minimum, straight-line distance between the laser modules and the molten glass remained constant, and the central strike angle was changed (e.g., by changing the module tilt angle). The coverage may be increased further by moving the laser modules farther away from the molten glass. However, this may not be an option where laser modules are installed in a confined space.

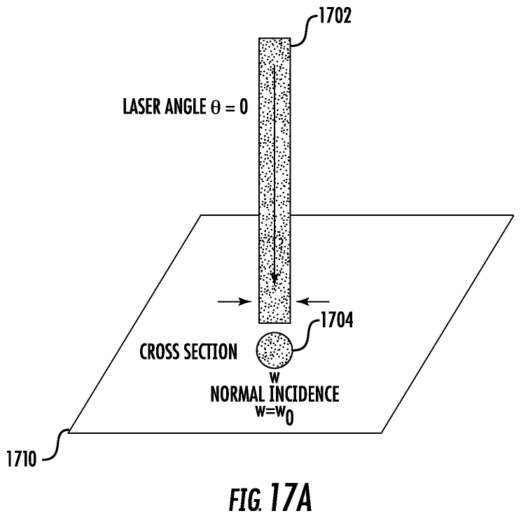

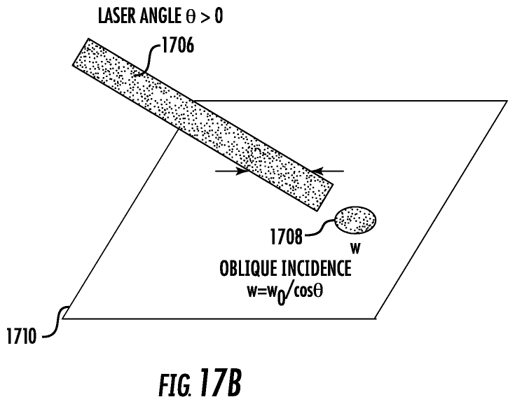

While an increase in the absolute value of central strike angles for a laser module may increase the coverage for that laser module, increasing the absolute value of central strike angles may cause reductions in the beam energy delivered to the glass at certain locations and may also cause deviations in the beam energy delivered to different locations. These concepts are illustrated further in FIGS. 17A-17B. FIGS. 17A-17B are schematic views illustrating laser beams striking a face of molten glass at different angles and the resulting laser beam shapes generated therefrom. FIGS. 17A and 17B illustrate laser beams incident on a portion of molten glass, such that the laser beam forms a laser beam shape on the molten glass. FIG. 17A illustrates a laser beam 1702 incident on a portion of molten glass 1710, such that the laser beam forms a laser beam shape 1704 on the molten glass 1710. FIG. 17B illustrates a laser beam 1706 incident on a portion of molten glass 1710, such that the laser beam forms a laser beam shape 1708 on the molten glass 1710. The molten glass 1710 is positioned at the location of the opposing arrows in both FIGS. 17A and 17B.

In FIG. 17A, the strike angle of the laser beam 1702 to the portion of molten glass 1710 is 0 degrees so that the strike angle is normal to the portion of molten glass 1710, thereby causing the laser beam 1702 to form a laser beam shape 1704 on the molten glass 1710. The laser beam 1702 has a width w₀, and the laser beam shape 1704 has a width w that is equal to the width w₀ of the laser beam 1702. In FIG. 17B, the strike angle of the laser beam 1706 to the portion of molten glass 1710 is greater than 0 degrees so that the strike angle is oblique to the portion of molten glass 1710, thereby causing the laser beam 1706 to form a laser beam shape 1708 on the molten glass 1710. The laser beam 1706 has a width w₀, and the laser beam shape 1708 has a width w that is equal to the width w₀ of the laser beam 1706 divided by the cosine of the laser angle θ (i.e., w=w₀/cos (θ)). As indicated by laser beam shape 1704 of FIG. 17A and the laser beam shape 1708 of FIG. 17B, the energy density of the laser beam 1706 at the face of the molten glass 1710 is less in FIG. 17B than the energy density of the laser beam 1706 at the face of the molten glass 1710 in FIG. 17A. This is due to the increased strike angle for the laser beam 1706 in FIG. 17B. As the strike angle of a laser beam increases, the power density of the laser beam over portions of molten glass 1710 decreases, thereby causing an uneven distribution of laser energy density over the molten glass 1710.

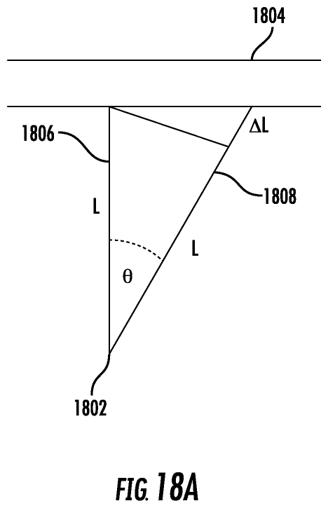

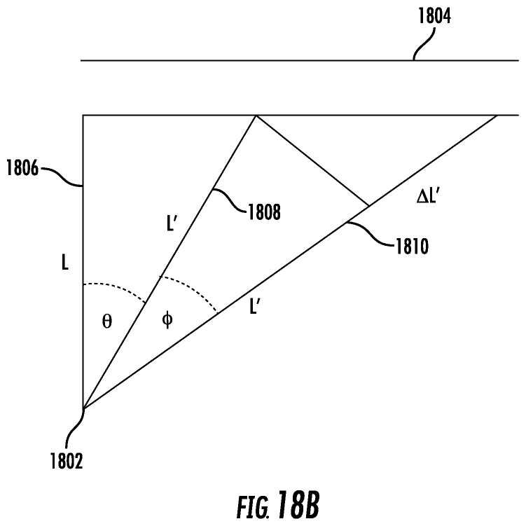

Additionally, FIGS. 18A-18B illustrate lengths that a laser beam travels at various angles before reaching molten glass material. FIGS. 18A-18B illustrates the additional distance (indicated by “ΔL”) that laser beams would travel from laser beam source 1802 to molten glass 1804 when the laser beam is at an angle θ from normal to molten glass 1804. The laser beam source 1802 may be an optical element (e.g., reflecting apparatus 248 (see FIG. 2C) such as a galvo) where an optical element is used. When a first laser beam 1806 is emitted at an angle that is normal to a face of the molten glass 1804, the first laser beam 1806 is required to travel some distance L. However, when a second laser beam 1808 is emitted at an angle θ relative to the face of the molten glass 1804, the second laser beam 1808 is required to travel a larger distance L′ (see FIG. 18B), with the difference between the distance L′ and the distance L being ΔL. The geometry illustrated in FIG. 18A is similar to the geometry for the system 300 illustrated in FIG. 3, with the first laser beam 1806A travelling at an angle perpendicular to the molten glass 1804 similar to the central directions 308, 318, 328, 338. The angle θ is zero for the first laser beam 1806. As the absolute value of the angle θ is increased, the laser beams begin to travel an additional distance ΔL, making the properties for these laser beams different from the first laser beam 1806A. FIG. 18B illustrates another additional distance (indicated by “ΔL′”) that a third laser beam 1810 would travel from laser beam source 1802 to molten glass 1804. In this example, the third laser beam 1810 emitted at an angle of φ+θ relative to the face of the molten glass 1804, and the third laser beam 1810 is emitted at an angle φ relative to the second laser beam 1808. The third laser beam 1810 is required to travel a larger distance, with the difference between this larger distance and the distance L′ being ΔL′. The geometry illustrated in FIG. 18B is similar to the geometry for the systems illustrated in FIGS. 4-8, with the scan angle ranges not being symmetric about the normal angle to the molten glass 1804. Instead, the central angle in FIG. 18B is (φ+θ)/2, and the scan angle range spans from zero to an angle of φ+θ. Thus, due to the added travel distances as the angle increases from zero to an angle of φ+θ, the properties are different as the laser beams are scanned at different locations.

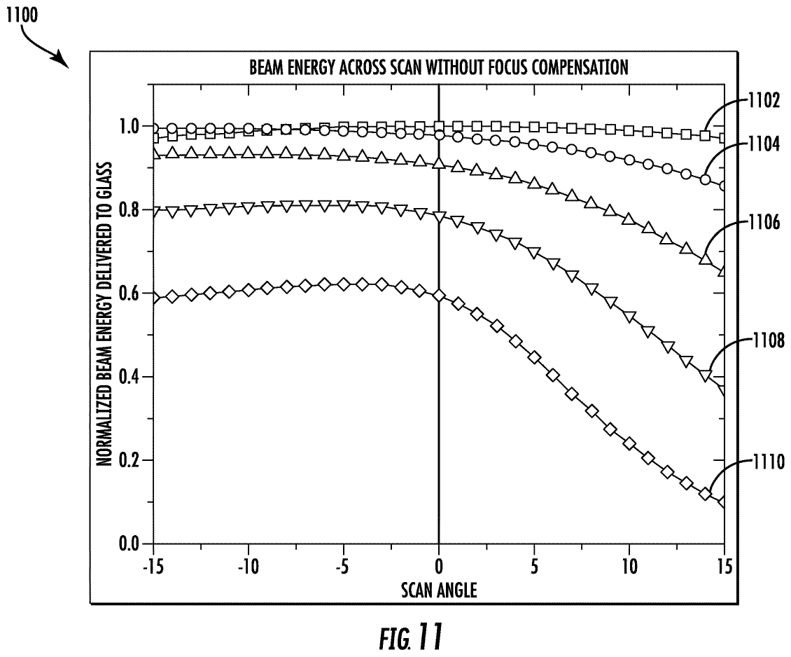

FIG. 11 is a line graph 1100 illustrating the normalized beam energy delivered to glass at different scan angles when different central strike angles are used and where no focus compensation is used. No static focus compensation or dynamic focus compensation optics were used to obtain the results illustrated in the line graph 1100, and the example shown in FIG. 11 shows results of a system having a system numerical aperture value of around 0.01. As used herein, a numerical aperture value is a dimensionless number that characterizes the range of angles over which the system can accept or emit light. In the line graph 1100, the normalized laser beam energy levels are included on the y-axis, and the scan angle is included on the x-axis in degrees. With high central strike angles, the beam energy decreased much more rapidly at higher scan angles. All normalized laser beam energy levels are normalized relative to the maximum laser beam energy level, which was accomplished by the plotline 1102 at a scan angle of around 0 degrees.

Where central strike angles were above zero, smaller scan angles resulted in shorter distances between the laser module and the molten glass relative to larger scan angles. For example, where a 60 degree central strike angle was used, the distance from the laser module to the molten glass was smaller along a scan angle of −15 degrees than it was along a scan angle of 0 degrees, and the distance from the laser module to the molten glass was smaller along a scan angle of 0 degrees than it was along a scan angle of 15 degrees.

For the plotline 1102, the central strike angle was zero degrees. The plotline 1102 was at a normalized beam energy of 1.0 at a scan angle of about zero degrees, and the plotline 1102 remained at normalized beam energy levels at or above 0.97 at all scan angles ranging from −15 degrees to 15 degrees.

For the plotline 1104, the central strike angle was fifteen degrees. The plotline 1104 began with a normalized beam energy of around 1.0 at a scan angle of −15 degrees. The plotline 1104 decreased to a normalized beam energy of around 0.975 at a scan angle of 0 degrees, and the plotline 1104 decreased to a normalized beam energy of around 0.85 at a scan angle of 15 degrees. Thus, while there was a decrease of around 0.025 in normalized beam energy from a scan angle of −15 degrees to a scan angle of 0 degrees, there was a decrease of around 0.125 in normalized beam energy from a scan angle of 0 degrees to a scan angle of 15 degrees. With a change in the scan angle from −15 degrees to 15 degrees, the normalized laser beam energy decreased by about 15.0%.

For the plotline 1106, the central strike angle was thirty degrees. The plotline 1106 began with a normalized beam energy of around 0.93 at a scan angle of −15 degrees. The plotline 1106 decreased to a normalized beam energy of around 0.90 at a scan angle of 0 degrees, and the plotline 1106 decreased to a normalized beam energy of around 0.65 at a scan angle of 15 degrees. Thus, while there was a decrease of around 0.03 in normalized beam energy from a scan angle of −15 degrees to a scan angle of 0 degrees, there was a decrease of around 0.15 in normalized beam energy from a scan angle of 0 degrees to a scan angle of 15 degrees. With a change in the scan angle from −15 degrees to 15 degrees, the normalized laser beam energy decreased by about 30.1%.

For the plotline 1108, the central strike angle was forty five degrees. The plotline 1108 began with a normalized beam energy of around 0.80 at a scan angle of −15 degrees. The plotline 1108 decreased to a normalized beam energy of around 0.78 at a scan angle of 0 degrees, and the plotline 1108 decreased to a normalized beam energy of around 0.35 at a scan angle of 15 degrees. Thus, while there was a decrease of around 0.02 in normalized beam energy from a scan angle of −15 degrees to a scan angle of 0 degrees, there was a decrease of around 0.43 in normalized beam energy from a scan angle of 0 degrees to a scan angle of 15 degrees. With a change in the scan angle from −15 degrees to 15 degrees, the normalized laser beam energy decreased by about 56.3%.

For the plotline 1110, the central strike angle was sixty degrees. The plotline 1110 began with a normalized beam energy of around 0.59 at a scan angle of −15 degrees. The plotline 1110 showed a slight increase in normalized beam energy to around 0.62 at a scan angle of −5 degrees, and the plotline 1110 had a normalized beam energy of around 0.60 at a scan angle of 0 degrees. The plotline 1110 decreased to a normalized beam energy of around 0.10 at a scan angle of 15 degrees. Thus, while the normalized beam energy for plotline 1110 was about the same at a scan angle of −15 degrees and a scan angle of zero degrees, the normalized beam energy for plotline 1110 decreased significantly to about 0.1 at a scan angle of 15 degrees. With a change in the scan angle from −15 degrees to 15 degrees, the normalized laser beam energy decreased by about 83.1%. Where central strike angle of 50 degrees or higher are used, laser beams may strike the glass at a grazing incidence, significantly reducing the energy density and process resolution. The line graph 1100 is summarized in Table 2 below.

TABLE 2
Beam Energy Levels Without Focus Compensation

| | Normalized Laser | Normalized Laser | |
|---|---|---|---|
| Central Strike | Beam Energy | Beam Energy | |
| Angle | at −15 Degree | at −15 Degree | Percentage |
| (degrees) | Scan Angle | Scan Angle | Decrease |
| 0 | 0.97 | 0.97 | 0% |
| 15 | 1.0 | 0.85 | 15.0% |
| 30 | 0.93 | 0.65 | 30.1% |
| 45 | 0.80 | 0.35 | 56.3% |
| 60 | 0.59 | 0.10 | 83.1% |

As illustrated in Table 2, the magnitude of the percentage decreases in normalized laser beam energy grew larger as the central strike angle increased past 60 degrees. One reason for this change is the difference in the distance between the laser module and the molten glass at a −15 degree scan angle and at a 15 degree scan angle, with this distance being greater for the 15 degree scan angle.

In various embodiments contemplated herein, static focus compensation optics and/or dynamic focus compensation optics may be integrated into systems. By using static focus compensation optics and/or dynamic focus compensation optics, systems using laser modules oriented at high central strike angles may have an increased laser beam energy relative to other comparable systems that do not use any static focus compensation optics or dynamic focus compensation optics. In some embodiments, systems having static focus compensation optics and/or dynamic focus compensation optics may possess system numerical aperture values greater than or equal to about 0.01. Where this is the case, static focus compensation or dynamic focus compensation optics may rapidly adjust the spot size of the laser beam to compensate for any beam divergence caused by the increase in the optical path length of the laser beam. Systems with numerical apertures greater than or equal to about 0.01 may be advantageous if greater spatial resolution is required to achieve desired thickness control. For example, smaller spots yield narrower heat affected zones and may provide more thickness control resolution. Where system numerical apertures are greater than or equal to about 0.01, static focus compensation optics and/or dynamic focus compensation optics are particularly useful to improve the thickness control resolution. Where system numerical apertures are less than about 0.01, static focus compensation optics and dynamic focus compensation optics have a reduced impact because generated beams are effectively collimated and the extra optical path length is often inconsequential.

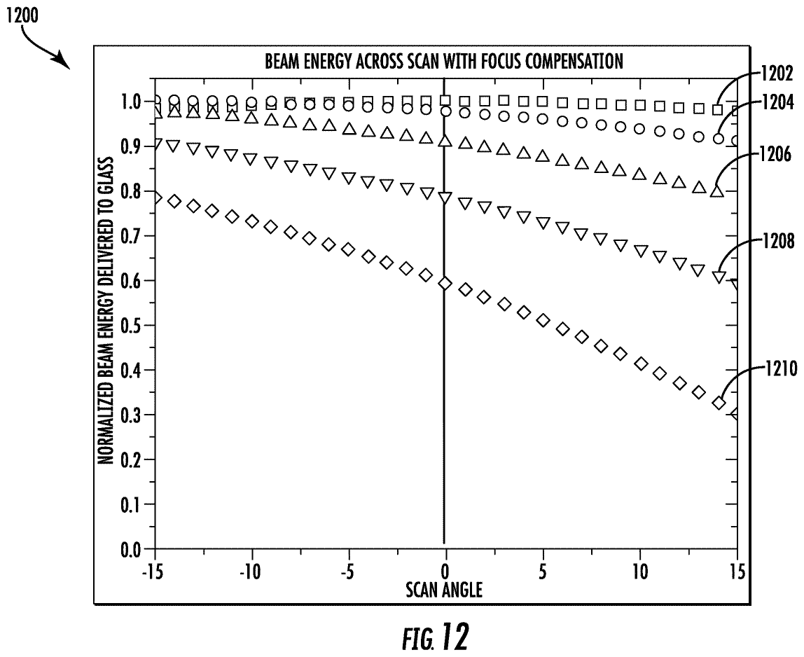

FIG. 12 is a line graph illustrating the normalized beam energy at a face of molten glass at different scan angles when different central strike angles are used and where focus compensation is used. Static focus compensation optics and/or dynamic focus compensation optics were used to obtain the results illustrated in the line graph 1200. The static focus compensation optics and/or dynamic focus compensation optics significantly reduced the decline in laser beam energy where larger central strike angles (in terms of absolute value) were used.

In the line graph 1200, the normalized laser beam energy levels are included on the y-axis, and the scan angle is included on the x-axis in degrees. With larger central strike angles (in terms of absolute value), the beam energy decreased more rapidly at higher scan angles. All normalized laser beam energy levels are normalized relative to the maximum laser beam energy level, which was accomplished by the plotline 1202 at a scan angle of around 0 degrees.

Where central strike angles were greater than zero, smaller scan angles resulted in shorter distances between the laser module and the molten glass relative to larger scan angles. For example, where a 60 degree central strike angle was used, the distance from the laser module to the molten glass was smaller for a scan angle of −15 degrees than it was along a scan angle of 0 degrees, and the distance from the laser module to the molten glass was smaller along a scan angle of 0 degrees than it was along a scan angle of 15 degrees. By contrast, where central strike angles were less than zero, smaller scan angles resulted in greater distances between the laser module and the molten glass relative to larger scan angles.

For the plotline 1202, the central strike angle was zero degrees. The plotline 1202 was at a normalized beam energy of 1.0 at a scan angle of about zero degrees, and the plotline 1202 remained at normalized beam energy levels at or above around 0.98 at all scan angles ranging from −15 degrees to 15 degrees.

For the plotline 1204, the central strike angle was fifteen degrees. The plotline 1204 began with a normalized beam energy of around 1.0 at a scan angle of −15 degrees. The plotline 1204 decreased to a normalized beam energy of around 0.97 at a scan angle of 0 degrees, and the plotline 1204 decreased to a normalized beam energy of around 0.90 at a scan angle of 15 degrees. Thus, while there was a decrease of around 0.03 in normalized beam energy from a scan angle of −15 degrees to a scan angle of 0 degrees, there was a decrease of around 0.07 in normalized beam energy from a scan angle of 0 degrees to a scan angle of 15 degrees. With a change in the scan angle from −15 degrees to 15 degrees, the normalized laser beam energy decreased by about 10.0%.

For the plotline 1206, the central strike angle was thirty degrees. The plotline 1206 began with a normalized beam energy of around 0.98 at a scan angle of −15 degrees. The plotline 1206 decreased to a normalized beam energy of around 0.90 at a scan angle of 0 degrees, and the plotline 1206 decreased to a normalized beam energy of around 0.78 at a scan angle of 15 degrees. Thus, there was a decrease of around 0.08 in normalized beam energy from a scan angle of −15 degrees to a scan angle of 0 degrees, and there was a decrease of around 0.12 in normalized beam energy from a scan angle of 0 degrees to a scan angle of 15 degrees. With a change in the scan angle from −15 degrees to 15 degrees, the normalized laser beam energy decreased by about 20.4%.

For the plotline 1208, the central strike angle was forty five degrees. The plotline 1208 began with a normalized beam energy of around 0.91 at a scan angle of −15 degrees. The plotline 1208 decreased to a normalized beam energy of around 0.78 at a scan angle of 0 degrees, and the plotline 1208 decreased to a normalized beam energy of around 0.60 at a scan angle of 15 degrees. Thus, there was a decrease of around 0.13 in normalized beam energy from a scan angle of −15 degrees to a scan angle of 0 degrees, and there was a decrease of around 0.18 in normalized beam energy from a scan angle of 0 degrees to a scan angle of 15 degrees. With a change in the scan angle from −15 degrees to 15 degrees, the normalized laser beam energy decreased by about 34.1%.

For the plotline 1210, the central strike angle was sixty degrees. The plotline 1210 began with a normalized beam energy of around 0.79 at a scan angle of −15 degrees. The plotline 1210 had a normalized beam energy of around 0.60 at a scan angle of 0 degrees. The plotline 1210 decreased to a normalized beam energy of around 0.30 at a scan angle of 15 degrees. Thus, there was a decrease of around 0.19 in normalized beam energy from a scan angle of −15 degrees to a scan angle of 0 degrees, and there was a decrease of around 0.30 in normalized beam energy from a scan angle of 0 degrees to a scan angle of 15 degrees. With a change in the scan angle from −15 degrees to 15 degrees, the normalized laser beam energy decreased by about 62.0%. The line graph 1200 is summarized in Table 3 below.

TABLE 3
Beam Energy Levels With Focus Compensation

| | Normalized Laser | Normalized Laser | |
|---|---|---|---|
| Central Strike | Beam Energy | Beam Energy | |
| Angle | at −15 Degree | at 15 Degree | Percentage |
| (degrees) | Scan Angle | Scan Angle | Decrease |
| 0 | 0.98 | 0.98 | 0% |
| 15 | 1.0 | 0.90 | 10.0% |
| 30 | 0.98 | 0.78 | 20.4% |
| 45 | 0.91 | 0.60 | 34.1% |
| 60 | 0.79 | 0.30 | 62.0% |

A comparison of Table 2 and Table 3 reveals that the use of focus compensation improved the normalized laser beam energy at a 15 degree scan angle and also helped reduce the percentage decrease values. While the percentage decrease values in normalized laser beam energy from a scan angle of −15 degrees to 15 degrees were improved by focus compensation, focus compensation did not eliminate these decreases. The remaining decreases are at least partially caused by cosine errors and Fresnel reflections caused by the large strike angle. Variations may at least partially be improved by modulating the laser power versus scan field to adjust for the power lost from Fresnel reflections. The output energy of a laser module may be increased during laser scanning as the strike angles increase (e.g., when laser beams are directly at an angle perpendicular to the surface of the molten glass, the output energy may be made higher than other scenarios when the laser beams are directed at other angles that are not perpendicular to the surface of the molten glass), and this may compensate for the beam energy that is naturally reflected from the glass due to high angles of incidence.

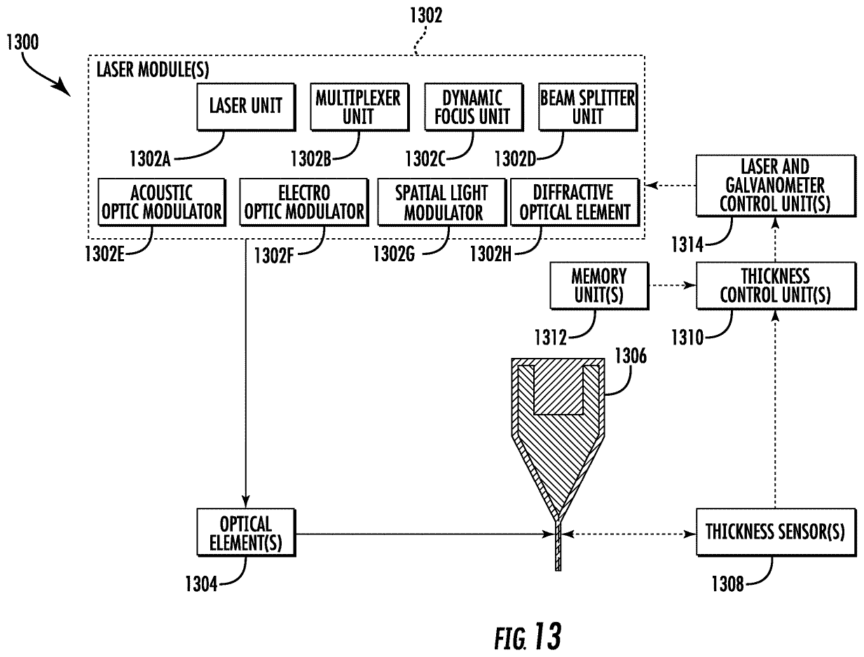

Additionally, these variations may at least partially be improved with beam compensation optics and a spatial light modulator 1302G (see FIG. 13) to compensate for the off-axis beam distortion. While off-axis scanning results in cosine error beam distortions on the glass, this may be at least partially addressed by positioning a tool such as a spatial light modulator 1302G in the beam path, with the spatial light modulator 1302G being synchronized with other beam steering optics. The spatial light modulator 1302G may modify the shape of the laser beam to compensate for off axis distortion at high response rates. The spatial light modulator 1302G may operate in at a frequency of about 50 hertz to about 110 hertz, about 60 hertz to about 100 hertz, or about 70 hertz to about 90 hertz. Additionally or alternatively, diffractive optical elements 1302H (see FIG. 13) may be used to modify incident phase fronts to pre-determined profiles through optical interference effects, and these diffractive optical elements 1302H may be custom designed to a particular system in some embodiments. The diffractive optical element 1302H may also be configured to compensate for cosine errors caused by large glass incident angles. However, in some embodiments, the diffractive optical element 1302H may be omitted, and the optical element(s) 1304 may be used instead to compensate for cosine errors. In some embodiments, no optical element(s) 1304 is included.

FIG. 13 is a block diagram illustrating an exemplary laser beam control system 1300. The system 1300 may be used to provide closed loop control of a thickness for molten glass during glass formation. The system 1300 includes one or more thickness sensors 1308. The thickness sensor(s) 1308 measure the thickness of the molten glass 1306 as glass is being formed to obtain a thickness trace. However, in some embodiments, the thickness sensor(s) 1308 may measure the thickness of the molten glass 1306 after the molten glass 1306 has been partially cooled glass or on fully cooled glass that have been cut. The thickness trace received at the thickness sensor(s) 1308 is then communicated by the thickness sensor(s) 1308 to one or more thickness control unit(s) 1310. The thickness control unit(s) 1310 may assist in maintaining a glass thickness proximate to a desired target. In some embodiments, the thickness control unit(s) 1310 may account for a variety of variables that impact the thickness of the molten glass 1306. The thickness control unit(s) 1310 may receive a target thickness profile from one or more memory unit(s) 1312. The target thickness profile may target a uniform thickness across a width of the molten glass in some embodiments. However, the target thickness profile may target a variable thickness across a width of the molten glass in other embodiments. For example, the target thickness profile may define a parabolic curvature, a quadratic curvature, a sinusoidal curvature, etc. The thickness control unit(s) 1310 may receive other data from the memory unit(s) 1312 as well.

Based on the available input information such as the target thickness profile and any thickness traces, the thickness control unit(s) 1310 may generate a power profile, and the thickness control unit(s) 1310 may be configured to send this power profile to one or more laser and galvanometer control unit(s) 1314. This power profile is configured to be used to control the operation of the laser module(s) 1302. The laser and galvanometer control unit(s) 1314 may then cause power to be applied with the laser module(s) 1302, with this power being applied to a specific location to accomplish a glass thickness according to the power profile. The laser module(s) 1302 generate a laser beam, and this laser beam may be emitted directly towards the molten glass 1306 in some embodiments (e.g., without the optical element(s) 1304 illustrated). However, in other embodiments such as the embodiment illustrated in FIG. 13, one or more optical elements 1304 may be included to redirect the laser beam towards the molten glass 1306 may be similar to those illustrated in FIG. 2C. The use of optical element(s) 1304 may be beneficial where limited space is available proximate to the molten glass 1306. The optical element(s) 1304 may include a reflector in some embodiments, but optical element(s) 1304 may additionally or alternatively include other elements such as optical lenses, refractive elements, etc. Even where optical element(s) are utilized, it may be beneficial to position the laser module(s) 1302 proximate to the molten glass 1306 to increase the amount of laser energy at the face of the molten glass 1306. While the optical element(s) 1304 are illustrated as being a separate component from the laser module(s) 1302 in FIG. 13, one or more of the optical element(s) 1304 may be provided within the laser module(s) 1302 in some embodiments.

The laser module(s) 1302 may each optionally include a laser unit 1302A, a multiplexer unit 1302B, a dynamic focus unit 1302C, a beam splitter unit 1302D, an acoustic optic modulator 1302E, an electro optic modulator 1302F, a spatial light modulator 1302G, and/or a diffractive optical element 1302H. The laser unit 1302A may be the unit within the laser module(s) 1302 that generates a laser beam. The multiplexer unit 1302B may multiplex one or more laser beams. The multiplexer unit 1302B may be a time multiplexer that routes the laser beam among various pathways on a time basis. Alternatively, the multiplexer unit 1302B may be a spatial multiplexer that routes the laser beam among various pathways simultaneously. The multiplexer unit 1302B may operate temporally, spatially, or spatial-temporally, for example. In some examples, the multiplexer unit 1302B may be configured to route a laser beam along various pathways. Multiplexing the laser beam may provide one or more advantages, such as allowing for the scaling of the laser beam control system.

The dynamic focus unit 1302C may be configured to correct for changes in the distance from laser module 1302 to the molten glass 1306. A beam splitter unit 1302D may allow a laser to be optically coupled to more than one optical fiber. In some further embodiments, all the optical fibers may be optically coupled to a single laser using a series of beam splitters.

In some embodiments, the laser module(s) 1302 may comprise at least one of a modulation device such as an acoustic optic modulator 1302E or an electro optic modulator 1302F. However, the acoustic optic modulator 1302E and/or the electro optic modulator 1302F may be positioned at other locations in the system 1300 in other embodiments. The acoustic optic modulator 1302E and the electro optic modulator 1302F may rapidly modulate a continuous laser beam, providing improved power control and pulse-to-pulse stability and repeatability. Pulse-width modulation strategies with standard pulsed lasers frequently lead to over/under shoots in pulse amplitudes between triggers, which may add process noise and lead to poor thickness control capabilities. However, tools such as an acoustic optic modulator 1302E and an electro optic modulator 1302F may be used to externally gate the laser pulse. Where an acoustic optic modulator 1302E and/or an electro optic modulator 1302F are used, laser module(s) 1302 may fire continuously at a fixed duty cycle and the pulse width may be modulated with high-speed acoustic optic modulators 1302E and/or electro optic modulators 1302F. This may yield pulses with sharp and repeatable rise/fall characteristics, and this may also minimize pulse over/undershoot anomalies. The use of acoustic optic modulators 1302E and/or electro optic modulators 1302F may also result in more consistent/repeatable performance from the precision thickness control laser system and simplify closed-loop control automation strategies. The acoustic optic modulators 1302E and/or electro optic modulators 1302F may also be used to correct for Fresnel reflection power losses caused by the large strike angle with a tilted module to maintain a similar energy density across the scan field. Systems including acoustic optic modulators 1302E and/or electro optic modulators 1302F may maintain a more uniform energy density at the face of molten glass relative to otherwise identical systems that do not include any acoustic optic modulator or the electro optic modulator.

Additionally, the laser module(s) 1302 may include a spatial light modulator 1302G and/or a diffractive optical element 1302H. Beam compensation optics and a spatial light modulator 1302G may be used to compensate for the off-axis beam distortion. Off-axis scanning results in cosine error beam distortions on the glass. To compensate for this beam distortion, a tool such as spatial light modulator 1302G may be incorporated into the beam path and may be synchronized with other beam steering optics. The spatial light modulator 1302G may modify the beam shape of the laser beam to compensate for off axis distortion at high response rates. Additionally or alternatively, a diffractive optical element 1302H may be used to modify beam shapes through optical interference effects, and the diffractive optical element 1302H may be custom designed to a particular system in some embodiments. The diffractive optical element 1302H may also be configured to compensate for cosine errors caused by large glass incident angles.

While laser energy may vary at different locations for a laser beam where laser modules are tilted at an angle, system 1300 may compensate for this. For example, thickness control unit(s) 1310 or other another unit may compute an expected power density of laser beam based on the incidence angle of laser beam. For example, thickness control unit(s) 1310 may cause laser and galvanometer control unit(s) 1314 to increase the power of the generated laser beam at some or all locations within the laser beam. As such, the system 1300 may maintain a same or similar power density as the laser beam is scanned across the molten glass.

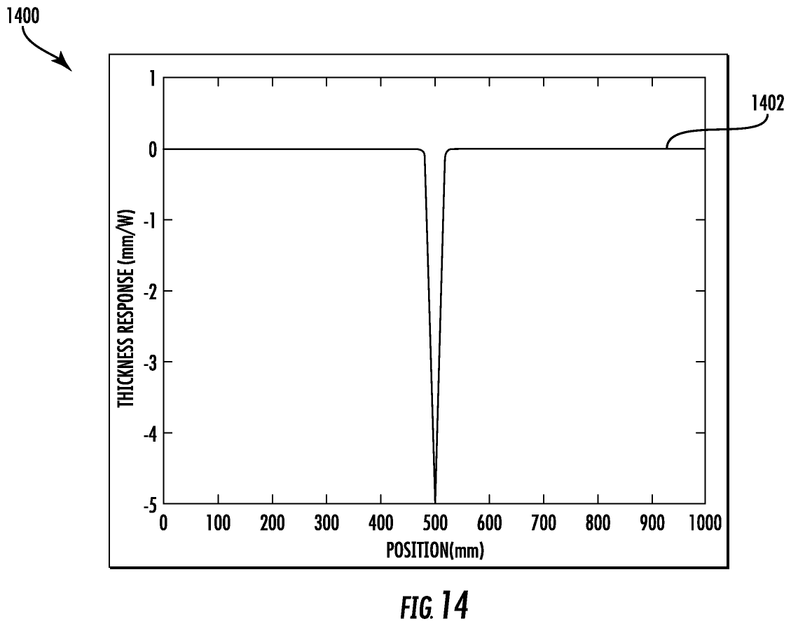

FIG. 14 is a line graph 1400 illustrating an example Gaussian response model for a thickness profile response of the molten glass to laser power. This line graph 1400 is merely a model and is not a measured response. In the illustrated example, a thickness profile response is input to change the thickness profile at the 500 millimeter position. As illustrated, the plotline 1402 remains at around 0 mm/W from the 0 millimeter position to around the 475 millimeter position, so these positions are generally not impacted by the thickness profile response. At around the 475 millimeter position, the mm/W value begins decreasing rapidly, and this value decreases to around-5 mm/W at around the 500 millimeter position. The mm/W value increases back to around 0 mm/W at around the 525 millimeter position. The mm/W value remains at zero from around the 525 millimeter position to the 1000 millimeter position, so these positions are generally not impacted by the thickness profile response. The response model in line graph 1400 is due to the incidence of a far-infrared laser (e.g., a CO2 based laser) focused to around a 5 millimeter spot and incident on the molten glass ribbon at the 500 millimeter position. The glass response may be a function of the composition, flow rate, temperatures, cooling curve, and other draw parameters.

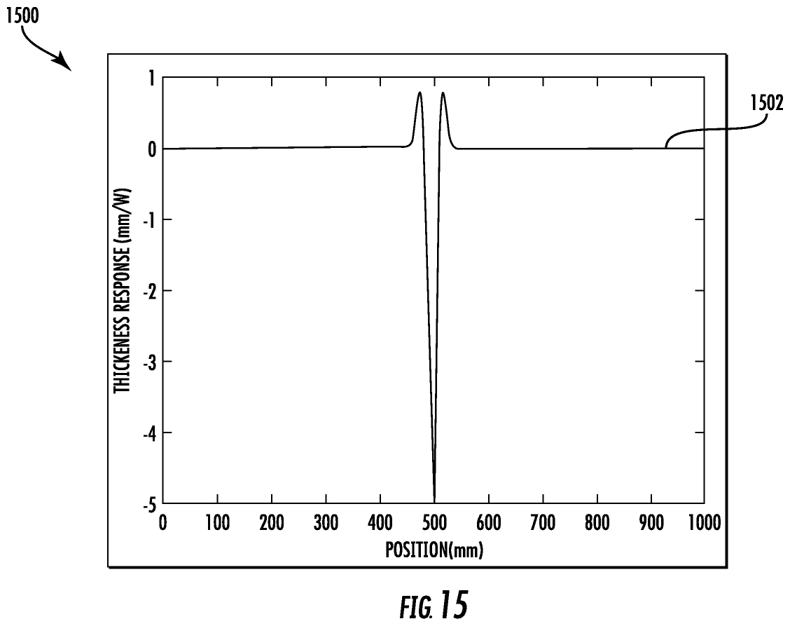

FIG. 15 is a line graph 1500 illustrating an example double Gaussian response model for a thickness profile response of the molten glass to laser power. This line graph 1500 is merely a model and is not a measured response. In the illustrated example, a thickness profile response is input to change the thickness profile at the 500 millimeter position. As illustrated, the plotline 1502 remains at around 0 mm/W from the 0 millimeter position to around the 450 millimeter position, so these positions are generally not impacted by the thickness profile response. At around the 450 millimeter position, the mm/W value begins increasing, and this value increases to around 0.75 mm/W at around the 475 millimeter position. Then, the mm/W value rapidly decreases to around-5 mm/W at around the 500 millimeter position. The mm/W value increases to around 0.75 mm/W at around the 525 millimeter position. The plotline 1502 then decreases to a level of around 0 mm/W from around the 550 millimeter position and remains at that level until the 1000 millimeter position, so these positions are generally not impacted by the thickness profile response. While Gaussian and double Gaussian response models are contemplated, other response models may also be used. For example, response models may be based on a raised cosine function, a Bessel function, etc.

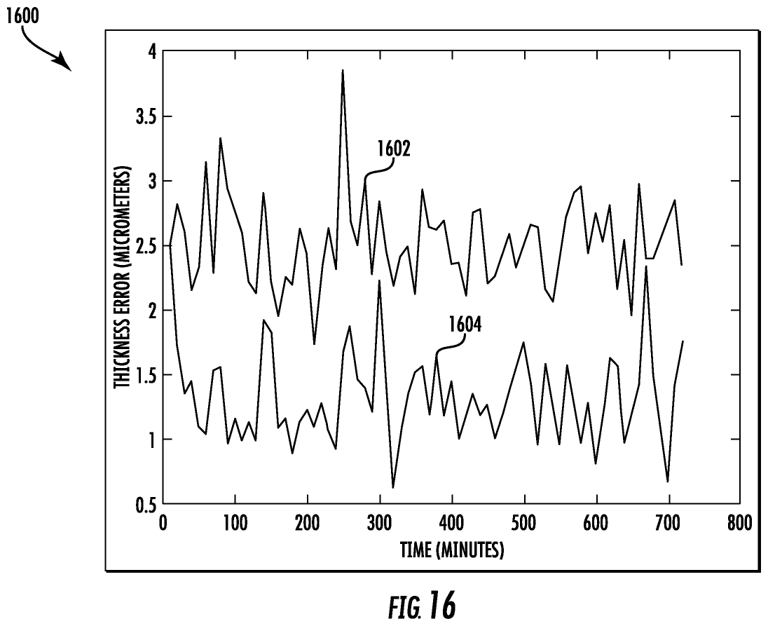

Closed loop control testing was also conducted to evaluate potential performance and stability of the scheme under closed loop control. FIG. 16 is a line graph 1600 illustrating the example thickness error before and after closed loop control testing. Testing was performed for approximately 12 hours or for 720 minutes. The thickness error may be evaluated by subtracting the minimum thickness from the maximum thickness over a 100 millimeter moving range window. In some embodiments, the thicknesses are measured at five millimeter increments across the glass, and the minimum thickness and the maximum thickness may be determined from these measured values.

Different control intervals may be used. For example, the control interval may be about 10 minutes, but the control interval could be changed to 5 minutes, 8 minutes, 15 minutes, or 20 minutes. A base control interval for the testing results illustrated in FIG. 16 was set at 10 minutes, but the intervals may be set to other periods (e.g., 1 minute, 2 minutes, 5 minutes, 15 minutes, 60 minutes, 240 minutes, 12 hours, 24 hours, 2 days, three days, etc.). By using a base control interval of 10 minutes, the actuator may have a superior resolution and response speed over other systems using a higher base control interval.

The current version of the system implements a cost function that may be either quadratic or non-quadratic. For example, the cost function may consider a moving range window value for the maximum thickness (e.g., maximum thickness within 100 millimeter moving range window) and/or the standard deviation of predicted thickness change, and the cost function is generally set to be a weighted combination of one of the moving range windows for the maximum thickness. Other cost functions may be used. The problem being solved is a constrained optimization, where the constraints are given by the allowable maximum change to the power profile per control interval and the max power the laser is capable of producing.

Line graph 1600 includes a plotline 1602 and a plotline 1604. The plotline 1602 illustrates the maximum thickness error during a 100 millimeter moving range window where no closed loop control was provided, and the plotline 1604 illustrates the maximum thickness error during a 100 millimeter moving range window where closed loop control was provided. The plotlines 1602 and 1604 both begin with the thickness error around 2.5 micrometers. The plotline 1602 generally remained around an average value of 2.52 micrometers throughout the entire 720 minute period illustrated on the graph 1600, with the maximum thickness error ranging between around 1.75 micrometers and around 3.8 micrometers. By contrast, the plotline 1604 generally remained around an average value of 1.32 micrometers throughout the 720 minute period illustrated on the graph 1600, with the maximum thickness error ranging between around 0.6 micrometers and 2.4 micrometers (when the value at time zero is excluded). This flatness control systems may improve both the long-term variation in the thickness of molten glass as well as the short-term variation. The graph 1600 illustrates that, under closed loop control, the average thickness error was reduced by about 47.62% and the maximum thickness error over a 720 minute window was reduced by about 36.84%. Additionally, other noise filtering techniques may be performed to further enhance the controller capability beyond the results shown in FIG. 16.

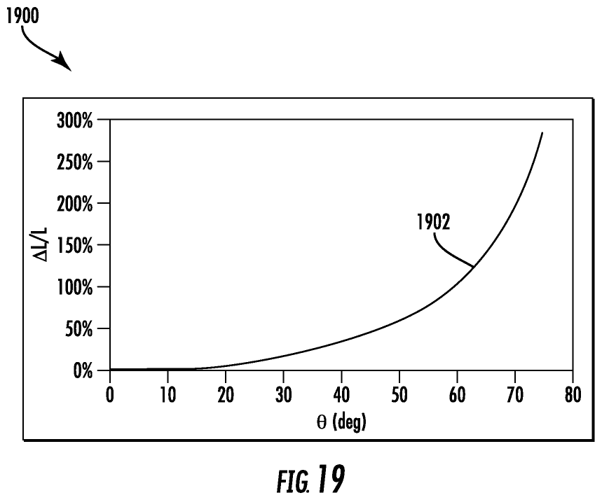

Turning now to FIG. 19, a chart 1900 is illustrated with a curve 1902 indicating a percentage of the additional distance (ΔL) a laser beam would need to travel relative to an original distance (indicated by “L”) where a laser beam is emitted at different angles relative to a direction normal to the face of molten glass, with zero degrees being normal to the face of the molten glass. At an angle of zero degrees, the percentage value for ΔL/L is zero. At angles between 0 degrees and about 20 degrees, the percentage value for ΔL/L remains around zero. At an angle of about 40 degrees, the percentage value for ΔL/L increases to around 25 percent. At an angle of about 50 degrees, the percentage value for ΔL/L increases to around 60 percent. At greater angles, the percentage value for ΔL/L increases even more rapidly. As ΔL/L increases to higher levels, the beam intensity variation across a scan angle range becomes considerable due to focus and cosine errors, and it may be beneficial to utilize further techniques to correct these focus and cosine errors.

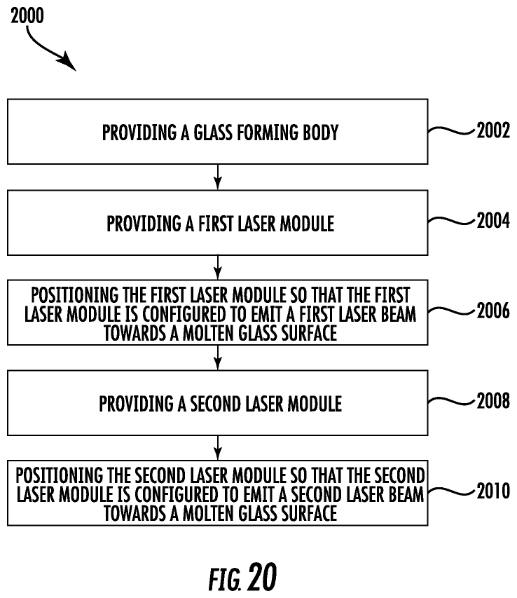

FIG. 20 is a flow chart illustrating an example method for manufacturing a laser thickness control system, in accordance with some embodiments discussed herein. At operation 2002, a glass forming body is provided, with the glass forming body being configured to facilitate the formation of glass. The glass forming body enables molten glass to flow along at least one surface of the glass forming body to form a glass ribbon comprising the molten glass. The molten glass defines a first face with a width extending from a first edge to a second edge, and this first face may be positioned above the root of the glass forming body or the first face may be positioned below the root of the glass forming body.

At operation 2004, a first laser module is provided. This laser module may be configured to generate a first laser beam. The first laser module may be configured to cause the first laser beam to be scanned at least partially along the width of the first face within a scan angle so as to apply heat to aid in thickness control of the glass ribbon that is formed into glass. At operation 2006, the first laser module is positioned so that the first laser module directs the first laser beam towards a face of the molten glass, and the face defines a normal direction that is normal to the face. The first laser module may cause the first laser beam to be scanned at least partially along the width of the first face within a scan angle range so as to apply heat to aid in thickness control of the glass ribbon that is formed into glass. The method 2000 may result in the formation of a system where the first laser beam travels with a first central facing direction when the first laser beam strikes the face of the molten glass. A first angle may be defined by the first central facing direction and the normal direction, and this first angle may be greater than zero degrees. In some embodiments, this first angle may be above zero degrees and less than about 50 degrees. In some embodiments, this first angle may be above zero degrees and less than about 45 degrees. In some embodiments, this first angle may be above zero degrees and less than about 40 degrees. In some embodiments, this first angle may be above zero degrees and less than about 35 degrees. In some embodiments, this first angle may be above zero degrees and less than about 30 degrees. In some embodiments, this first angle may be above zero degrees and less than about 25 degrees. In some embodiments, this first angle may be above zero degrees and less than about 20 degrees.

At operation 2008, a second laser module may optionally be provided, and this second laser module may be configured to generate a second laser beam. The second laser module may be configured to cause the second laser beam to be scanned at least partially along the width of the first face within a scan angle range so as to apply heat to aid in thickness control of the glass ribbon that is formed into glass. At operation 2010, the second laser module may be positioned so that the second laser module directs the second laser beam towards a face of the molten glass. The second laser module may cause the second laser beam to be scanned at least partially along the width of the first face within a scan angle range so as to apply heat to aid in thickness control of the glass ribbon that is formed into glass. The method 2000 may result in the formation of a system where the second laser beam travels in a second direction when the second laser beam strikes the face of the molten glass. A second angle may be defined by the second direction and the normal direction. The second angle may be equal to the first angle in some embodiments, but the second angle may be different from the first angle in some embodiments. In some embodiments, the second angle may be zero.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for forming a glass ribbon, the system comprising:
a glass forming body configured to enable molten glass to flow along a surface of the glass forming body to form a glass ribbon, wherein the glass ribbon defines a first face with a width extending from a first edge to a second edge; and
a first laser module configured to generate a first laser beam that is scanned at least partially along the width of the first face within a first scan angle range so as to apply heat to aid in thickness control of the glass ribbon,
wherein a first central facing direction of the first scan angle range for the first laser beam strikes the first face at a first central strike angle that is not normal to the first face.

2. The system of claim 1, wherein the first laser beam is spread at least partially along the width of the glass ribbon between the first edge and the second edge, wherein the first scan angle range is equal to an angle range between a first scan angle and a second scan angle, wherein the first scan angle is a minimum angle at which a portion of the first laser beam strikes the first face, and wherein the second scan angle is a maximum angle at which a portion of the first laser beam strikes the first face.

3. The system of claim 2, wherein the first scan angle range is greater than about 40 degrees.

4. The system of claim 1, wherein the first central strike angle is measured relative to a normal direction of the first face, and wherein the first central strike angle is greater than zero degrees and less than about fifty degrees.

5. The system of claim 1, wherein the first laser beam causes an increase in a temperature at the glass ribbon at an impact area, wherein the increase in the temperature causes a decrease in a viscosity of the glass ribbon at the impact area, and wherein the decrease in the viscosity of the glass ribbon results in a decrease in the thickness of the glass ribbon at the impact area.

6. The system of claim 1, further comprising:
a second laser module configured to generate a second laser beam that is scanned at least partially along the width of the first face within a second scan angle range so as to apply heat to aid in thickness control of the glass ribbon,
wherein a second central facing direction of the second scan angle range for the second laser beam strikes the first face at a second central strike angle.

7. The system of claim 6, wherein the first central strike angle and the second central strike angle are the same.

8. The system of claim 6, wherein the first central strike angle and the second central strike angle are different.

9. The system of claim 8, wherein the second central strike angle is equal to zero.

10. The system of claim 1, further comprising:
at least one optical element,
wherein the first laser module is configured to emit the first laser beam towards the at least one optical element, and wherein the at least one optical element is configured to redirect the first laser beam towards the first face.

11. The system of claim 10, wherein the at least one optical element comprises a reflector.

12. The system of claim 10, further comprising:
a regulating mechanism that is configured to adjust an orientation of the at least one optical element,
wherein adjustment of the orientation of the at least one optical element causes a change in a location where a laser beam contacts the first face of the glass ribbon.

13. The system of claim 1, further comprising:
a thickness sensor configured to determine a thickness of the glass ribbon at one or more locations; and
a thickness control unit,
wherein the thickness control unit is configured to receive thickness data from the thickness sensor, wherein the thickness control unit is configured to receive a target thickness profile, wherein the thickness control unit is configured to generate a power profile based on at least the thickness data and the target thickness profile, and wherein the power profile is configured to be used to control the operation of the first laser module.

14. The system of claim 13, wherein the target thickness profile maintains a uniform thickness across the width of the glass ribbon.

15. The system of claim 13, wherein the target thickness profile maintains a variable thickness across the width of the glass ribbon.

16. The system of claim 1, further comprising:
at least one of an acoustic optic modulator or an electro optic modulator,
wherein the acoustic optic modulator and the electro optic modulator are configured to modulate a generated laser beam to form the first laser beam.

17. The system of claim 16, wherein the first central strike angle is equal to about 30 degrees, wherein the first laser beam strikes the first face with a minimum energy density and a maximum energy density, and wherein the minimum energy density is less than about 21 percent of the maximum energy density.

18. The system of claim 1, further comprising:
at least one of a spatial light modulator or a diffractive optical element,
wherein the spatial light modulator or the diffractive optical element are configured to compensate for cosine errors caused by large glass incident angles.

19. The system of claim 1, wherein the glass forming body comprises a root, and wherein the first laser beam strikes the first face below the root of the glass forming body.

20. The system of claim 1, wherein the glass forming body comprises a root, and wherein the first laser beam strikes the first face above the root of the glass forming body.

21. The system of claim 1, wherein the first laser beam comprises light having a wavelength between about 400 nanometers and about 11000 nanometers.

22. A method of manufacturing a system for providing laser thickness control, the method comprising:
providing a glass forming body configured to enable molten glass to flow along at least one surface of the glass forming body to form a glass ribbon, and wherein the molten glass defines a first face with a width extending from a first edge to a second edge;
providing a first laser module that is configured to generate a first laser beam that is scanned at least partially along the width of the first face within a scan angle range so as to apply heat to aid in thickness control of the glass ribbon; and
positioning the first laser module so that the first laser module directs the first laser beam towards the first face,
wherein the first face defines a normal direction that is normal to the first face, and wherein a central facing direction of the scan angle range for the first laser beam strikes the first face at a central strike angle that is not normal to the first face.

23. The method of claim 22, further comprising:
providing a second laser module that is configured to generate a second laser beam that is scanned at least partially along the width of the first face within a second scan angle range so as to apply heat to aid in thickness control of the glass ribbon; and
positioning the second laser module so that the second laser module directs the second laser beam towards the first face.

24. A laser system for forming a glass ribbon, the laser system comprising:
a first laser module configured to generate a first laser beam that is scanned at least partially along a width of a first face of a glass ribbon, wherein molten glass flows along a surface of a glass forming body to form the glass ribbon, wherein the glass ribbon defines a first face with the width extending from a first edge to a second edge,
wherein the first laser beam is scanned within a first scan angle range along the width so as to apply heat to aid in thickness control of the glass ribbon,
wherein the first laser beam is aimed along the width such that a first central facing direction of the first scan angle range for the first laser beam strikes the first face at a first central strike angle that is not normal to the first face.
